(19) United States
(12) Patent Application Publication
(10) Pub. No.: US 2010/0182538 A1
(43) Pub. Date: Jul. 22, 2010

(54) LIQUID CRYSTAL DISPLAY DEVICE AND TELEVISION RECEIVER

(76) Inventor: Yoshiki Takata, Mie (JP)

Correspondence Address: NIXON & VANDERHYE, PC, 901 NORTH GLEBE ROAD, 11TH FLOOR, ARLINGTON, VA, 22203, US

(21) Appl. No.: 12/439,863

(22) PCT Filed: Oct. 25, 2007
(86) PCT No.: PCT/JP2007/070815

§ 371 Date: Mar. 4, 2009

(30) Foreign Application Priority Data
Nov. 16, 2006 (JP) 2006-310611

(51) Int. Cl. G02F 1/13357; G02F 1/1335

(52) U.S. Cl. 349/64; 349/104

(57) ABSTRACT

A liquid crystal display device includes: (I) a liquid crystal panel including (i) a pair of substrates, which sandwich a liquid crystal layer, and (ii) optical members each provided so as to face an external surface of each of the pair of substrates, which surface is opposite to an internal surface of the each of the pair of substrates that faces the liquid crystal layer, the optical members each including a polarizer in pair; and (II) a backlight provided so as to face a surface of the liquid crystal panel, the surface being opposite to a display surface of the liquid crystal panel. The liquid crystal display device further includes a near-infrared region absorbing member that absorbs light in a near-infrared region of 900 nm to 1000 nm, the near-infrared region absorbing member being provided at least either in the liquid crystal panel or between the liquid crystal panel and the backlight. In a case where the near-infrared region absorbing member is provided in the liquid crystal panel, the near-infrared region absorbing member in the liquid crystal panel is at least one of the following members: (a) one of the pair of polarizers that faces the display surface of the liquid crystal panel, (b) one of the pair of substrates that faces the backlight, (c) one of the optical members that faces an external surface of the substrate that faces the backlight, which surface is opposite to an internal surface of the substrate that faces the liquid crystal layer, and (d) a pressure sensitive adhesive layer for adhering any one of the optical members.

### TECHNICAL FIELD

The present invention relates to a liquid crystal display device including a backlight, and a television receiver.

### BACKGROUND ART

Conventionally, a remote controller for remotely controlling an electric appliance such as a television or an air conditioner generally carries out a remote control operation by use of infrared light because such the arrangement is available at a low price and convenient.

FIG. 12 is a graph showing a relation between wavelength (transmission wavelength of a remote controller) and relative intensity in light emitted from the remote controller that uses an infrared communication. The infrared communication by the remote controller uses near-infrared light in a near-infrared region, which light has a maximum relative intensity, for example, at a wavelength of 940 nm, as shown in FIG. 12.

In a television employing a liquid crystal display device, for example, a cold cathode fluorescent tube (CCFT) is generally used as a discharge lamp tube of a backlight source. In a tube of the discharge lamp tube, inactive gas such as neon (Ne) and argon (Ar), and mercury (Hg) are contained. As shown in FIG. 13, the mercury (Hg) emits light in the near-infrared region which light has a maximum relative intensity at a wavelength of 1015 nm. Further, the inactive gas emits light that has a maximum relative intensity at a wavelength of 910 nm, which is the near-infrared region.

FIG. 13 is a graph showing a relation between wavelength and relative intensity in light emitted from a backlight in the conventional liquid crystal display. FIG. 13 also shows spectrums on a liquid crystal panel. It is shown, in FIG. 13, that lights having wavelengths in the near-infrared region pass through a polarizer of the liquid crystal panel in the liquid crystal display device. Further, it is shown, in FIGS. 12 and 13, that wavelengths in the near-infrared region shown in FIG. 13, which are emitted from the liquid crystal display device, is included within the transmission wavelengths of the remote controller, which is shown in FIG. 12.

On this account, light having near-infrared wavelengths that is emitted from the liquid crystal panel, affects, as a noise, a receiving section in a peripheral electronic device of the liquid crystal panel, which receiving section receives a signal transmitted from the remote controller. That is, the noise comes into the receiving section. This causes a problem that the remote controller does not work, or causes malfunctions. Conventionally, such a problem was not a really big problem since a liquid crystal panel that is a noise source was not so large. However, as a large-size liquid crystal panel has been developed in recent years, the problem has become significant because a large amount of near-infrared light is emitted from a backlight of such a large-size liquid crystal panel.

On the other hand, it has been known that the similar problem also arises in a plasma display (see Patent Literatures 1 through 3).

In order to solve the problem, for example, Patent Literatures 1 through 3 disclose techniques in which a display filter containing a dye that absorbs near-infrared light is attached to a plasma display screen of a display device so that a plasma display panel is protected and near-infrared light emitted from the plasma display screen is shielded.

### Citation List

Patent Literature 1

Japanese Patent Application Publication, Tokukai, No. 2006-58896 A (published on Mar. 2, 2006) (Corresponding U.S. Patent Application No. 2003/156080 (published on Aug. 21, 2003))

Patent Literature 2

Japanese Patent Application Publication, Tokukai, No, 2002-251144 A (published on Sep. 6, 2002)

Patent Literature 3

Japanese Patent Application Publication, Tokukai, No. 2000-275432 (published on Oct. 6, 2000)

Patent Literature 4

Japanese Patent No. 2662399 B (registered on Jun. 13, 1997)

Patent Literature 5

Japanese Patent Application Publication, Tokukaihei, No. 10-152620 A (published on Jun. 9, 1998) (Corresponding U.S. Pat. No. 5,783,377 (published on Jul. 21, 1998))

Patent Literature 6

Japanese Patent Application Publication, Tokukaishou, No. 60-23451 A (published on Feb. 6, 1985) (Corresponding U.S. Pat. No. 4,622,179 (Nov. 11, 1986))

### SUMMARY OF INVENTION

However, in a case where a display filter that is formed independently to a liquid crystal panel is attached on a display surface of the liquid crystal panel in the similar manner to the conventional plasma display as disclosed in Patent Literatures 1 through 3, a defective ratio increases and a production yield decreases, thereby causing an increase in production cost. Note that a polarizer is required for displaying of a liquid crystal panel. Further, attachment of a display filter to a display surface of a liquid crystal panel indicates that the display filter is attached to a polarizer used for displaying.

More particularly, in a case where the display filter is applied to a liquid crystal display device, in order to check an effect that the display filter shields near-infrared light that passes through a polarizer of a liquid crystal panel, it is necessary that the display filter be attached to the polarizer of the liquid crystal panel. However, once the display filter is attached to the liquid crystal panel, it is not easy to detach the display filter. From this reason, in case where either one of the liquid crystal panel and the display filter has a defect, even if the other one does not have any problems, a set of the liquid crystal panel and the display filter is regarded as a defective product. Consequently, a defective ratio increases. Patent Literature 1 discloses that a transparent polymer film that constitutes a filter is provided so as to have a large total film thickness, thereby increasing a stiffness property so that detachability increases. However, this case also requires a detaching process. Further, such the large film thickness of the filter to be attached to a screen of a display leads to an increase in production cost.

Moreover, in the case where a display filter is attached to a liquid crystal panel, as described above, the following problem may occur, depending on the stiffness property of the display filter. That is, even if both the display filter and the liquid crystal panel have no defect, a set of the display filter and the liquid crystal panel may be defective due to air coming into an interface therebetween in attaching the display filter to the liquid crystal panel. Such the problem that air comes into the interface also leads to a decrease in display quality.

The present invention is accomplished in view of the above problems. An object of the present invention is to provide a liquid crystal display device and a television receiver, each of which can shield near-infrared light emitted from a backlight without decreasing a display quality, and each of which has a higher production yield compared with a case where a display filter is attached to a screen of a display.

A liquid crystal display device of the present invention includes: (I) a liquid crystal panel including (i) a pair of substrates, which sandwich a liquid crystal layer therebetween, and (ii) optical members each provided so as to face an external surface of each of the pair of substrates, which surface is opposite to an internal surface of the each of the pair of substrates that faces the liquid crystal layer, the optical members each including a polarizer in pair; and (II) a backlight provided so as to face a surface of the liquid crystal panel, the surface being opposite to a display surface of the liquid crystal panel. In order to achieve the object, the liquid crystal display device further includes a near-infrared region absorbing member, which absorbs light in a near-infrared region of 900 nm to 1000 nm, the near-infrared region absorbing member being provided at least either in the liquid crystal panel or between the liquid crystal panel and the backlight, in a case where the near-infrared region absorbing member is provided in the liquid crystal panel, the near-infrared region absorbing member in the liquid crystal panel being at least one of the following members: (a) one of the pair of polarizers that faces the display surface of the liquid crystal panel, (b) one of the pair of substrates that faces the backlight, (c) one of the optical members that faces an external surface of the substrate that faces the backlight, which surface is opposite to an internal surface of the substrate that faces the liquid crystal layer, and (d) a pressure sensitive adhesive layer for adhering the optical member.

In the arrangement, the near-infrared region absorbing member is a constituent of the liquid crystal panel that is essential for the liquid crystal display device, or is provided closer to the backlight than the liquid crystal panel. Therefore, it is not necessary that a near-infrared region absorbing member produced separately from the liquid crystal panel be attached to the liquid crystal panel. With the arrangement, it is possible to provide a liquid crystal display device which can shield near-infrared light emitted from a backlight, and which has a higher production yield compared with a case where a display filter is attached to a display screen.

More specifically, in the case where the near-infrared region absorbing member is provided in the liquid crystal panel, it is not necessary to produce the near-infrared region absorbing member separately from the liquid crystal panel. On this account, the number of components does not increase. Further, in a case where a display filter produced separately from a liquid crystal panel is attached to a display surface of the liquid crystal panel, the following problem is caused. That is, when either one of the filter and the panel has a defect, a set of the filter and the panel is regarded as a defective product, thereby causing an increase in defective ratio. However, with the aforementioned arrangements, since the near-infrared region absorbing member is a constituent of the liquid crystal panel, such the problem does not occur and the defective ratio does not increase. Consequently, it is possible to provide, at a low production cost, a liquid crystal display device which can shield near-infrared light, and which has a higher production yield compared with a case where a display filter is attached to a display screen.

Further, in a case where the near-infrared region absorbing member is provided closer to the backlight than the liquid crystal panel, it is not necessary to attach the near-infrared region absorbing member to the liquid crystal panel by use of an adhesive material (a pressure sensitive adhesive material). In this case, even if either one of the liquid crystal panel and the near-infrared region absorbing member is defective, it is possible to easily replace the defective one without detaching the near-infrared region absorbing member from the panel. As a result, it is possible to provide, at a low cost, a liquid crystal display device which can shield near-infrared light emitted from a backlight, and which has a higher production yield compared with a case where a display filter is attached to a display screen.

Further, according to the aforementioned arrangement, in a case where the near-infrared region absorbing member is provided closer to the display surface than the liquid crystal layer in the liquid crystal panel, only the polarizer that faces the display surface can be the near-infrared region absorbing member provided closer to the display surface than the liquid crystal layer in the liquid crystal panel. On this account, the arrangement (i) improves a production yield, and (ii) does not cause problems that are caused when a near-infrared absorbing display filter is attached to a display surface: for example, a problem caused due to air coming into an interface between the display panel and the near-infrared absorbing display filter, and a problem for detaching the display filter from the panel. Further, with the aforementioned arrangement, it is possible to shield light in the near-infrared region without decreasing luminance and brightness. This does not decrease a display quality.

It is preferable that the near-infrared region absorbing member has an absorptance of at least 30% with respect to the light in the near-infrared region.

As described above, the near-infrared region absorbing member is provided in the liquid crystal display device. Therefore, with the arrangement, even if light having a wavelength in the near-infrared region is emitted from the backlight, at least 30% of the light is absorbed.

As a result, it is possible to more surely prevent that a peripheral electronic device of the liquid crystal display device is caused to malfunction due to the light having a wavelength in the near-infrared region, emitted from the backlight, when the peripheral electronic device is operated by a remote controller.

As a result, it is possible to provide a liquid crystal display device which can further shield near-infrared light emitted from a backlight without decreasing a display quality.

Furthermore, in order to achieve the object, a television receiver of the present invention includes the liquid crystal display device.

This makes it possible to provide a television receiver which can shield near-infrared light emitted from a backlight without decreasing a display quality, and which has a higher production yield compared with a case where a display filter is attached to a display screen.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a graph showing relations between transmittance and wavelength of iodine and a dye in a near-infrared region absorbing member in a liquid crystal display device according to one embodiment of the present invention.

FIG. 2 is a cross sectional view illustrating an arrangement of the liquid crystal display device.

FIG. 3 is a cross sectional view illustrating an arrangement of a liquid crystal display device according to another embodiment of the present invention.

FIG. 4 is a graph showing relations between transmittance and wavelength of (i) a near-infrared region absorbing member that absorbs 50% of light in a near-infrared (900 nm to 1100 nm) region and (ii) a near-infrared region absorbing member that absorbs 90% of light in the near-infrared (900 nm to 1100 nm) region, in the liquid crystal display device.

FIG. 5 is a graph showing luminance ratio in the liquid crystal display device, where the near-infrared region absorbing member that absorbs 50% of light in the near-infrared (900 nm to 1100 nm) region is placed at arbitrary positions between a diffusing plate of a backlight and a liquid crystal panel.

FIG. 6 is a cross sectional view illustrating an arrangement of a modified example of the liquid crystal display device.

FIG. 7 is a block diagram showing an arrangement of a liquid crystal display device provided in a television receiver, according to further another embodiment of the present invention.

FIG. 8 is a block diagram showing an arrangement of the television receiver.

FIG. 9 is an exploded perspective view illustrating the arrangement of the television receiver.

FIG. 10 is an explanatory view illustrating an experimental arrangement for checking effects of the liquid crystal display device.

FIG. 11 is an explanatory view showing results of the experiments for checking the effects of the liquid crystal display device.

FIG. 12 is a graph showing a relation between wavelength and relative intensity in light emitted from a remote controller using an infrared communication.

FIG. 13 is a graph showing a relation between wavelength and relative intensity in light emitted from a backlight in a conventional liquid crystal display device.

FIG. 14 is a cross sectional view illustrating an exemplary arrangement of an essential part of a liquid crystal panel in a liquid crystal display device according to one embodiment of the present invention.

### REFERENCE SIGNS LIST

1: Active matrix substrate (Substrate)
2: Color filter substrate (Substrate)
3: Bottom polarizer (Polarizer, Optical member, Near-infrared region absorbing member)
4; Upper polarizer (Polarizer, Optical member, Near-infrared region absorbing member)
5: Bezel
6: Housing
7: Liquid crystal cell
8: Phase different film (Optical member, Near-infrared region absorbing member)
9: Phase different film (Optical member, Near-infrared region absorbing member)
10: Liquid crystal panel
11: Diffusing sheet (Optical member, Near-infrared region absorbing member)
12: Light-collecting sheet (Optical member, Near-infrared region absorbing member)
13: Polarized light reflecting sheet (Optical member, Near-infrared region absorbing member)
20: Backlight
21: Backlight frame
22: Discharge lamp tube
23: Diffusing plate (Light diffusing plate)
24: Pressure sensitive adhesive layer (Near-infrared region absorbing member)
30: Liquid crystal display device
40: Liquid crystal display device
41: Near-infrared absorbing polarizer (Near-infrared region absorbing member, Near-infrared region absorbing polarizer)
42: Near-infrared absorbing polarizer (Near-infrared region absorbing member, Near-infrared region absorbing polarizer)
50: Liquid crystal display device
51: Y/C separation circuit
52: Video chroma circuit
53: A/C converter
54: Liquid crystal controller
55: Liquid crystal panel
56: Backlight driving circuit
57: Backlight
58: Microcomputer
59: Gradation circuit
60: Television receiver
61: Tuner section
65: First housing
65a: Opening
66: Second housing
67: Operation circuit
68: Support member
71: Backlight
72: Remote controller
80: Source bus line
81: TFT
82: Insulating substrate
83: Gate electrode
84: Gate insulating film
85: Semiconductor layer
86: Amorphous silicon layer
87: Source electrode
88: Drain electrode
90: Interlayer insulating film
91: Pixel electrode
92: Alignment film
93: Insulating substrate
94: Color filter layer
95: Counter electrode
96: Alignment film

### DESCRIPTION OF EMBODIMENTS

### Embodiment 1

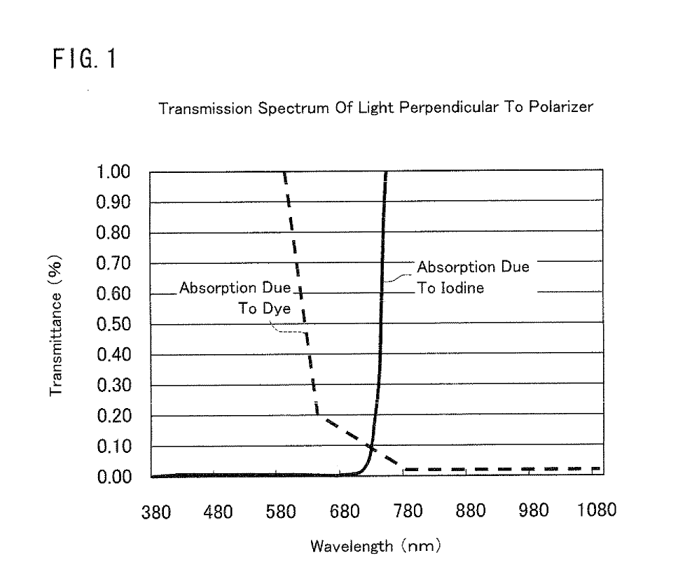

One embodiment of the present invention is described below with reference to FIGS. 1, 2, and 14.

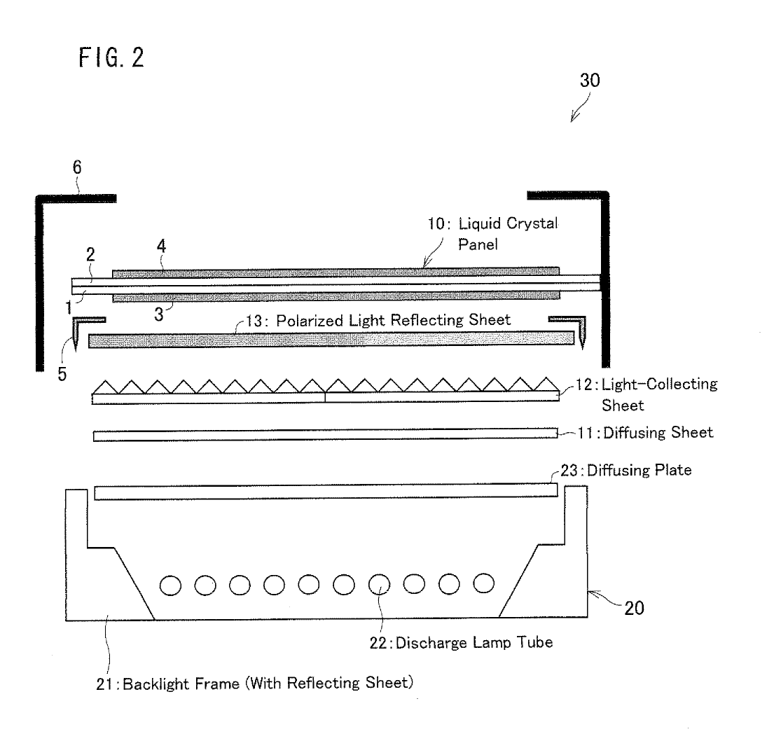

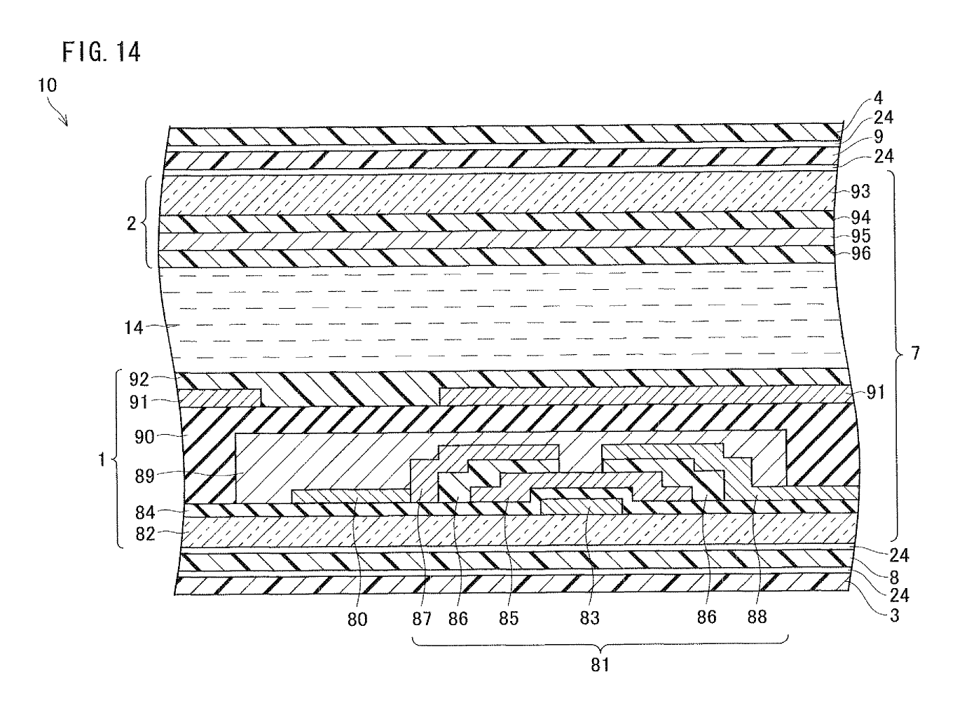

FIG. 2 is a cross sectional view illustrating an arrangement of a liquid crystal display device according to the present embodiment. FIG. 14 is a cross sectional view illustrating one exemplary arrangement of an essential part of a liquid crystal panel in the liquid crystal display device according to the present embodiment.

A liquid crystal display device 30 of the present embodiment, as illustrated in FIG. 2, includes a liquid crystal panel 10 and a backlight 20. The liquid crystal display device 30 further includes a diffusing sheet 11, a light-collecting sheet 12, and a polarized light reflecting sheet 13, which are laminated in this order from the backlight 20, between the liquid crystal panel 10 and the backlight 20.

The polarized light reflecting sheet 13 is supported by a bezel 5 at its periphery, and the liquid crystal panel 10 is supported by a housing 6 at its periphery.

As illustrated in FIG. 14, the liquid crystal panel 10 includes a liquid crystal cell 7 in which a liquid crystal layer 14 is sandwiched between an active matrix substrate 1 (an array substrate) and a color filter substrate 2 (a counter substrate). The liquid crystal panel 10 is arranged such that a bottom polarizer 3 and an upper polarizer 4 are provided on respective sides of the liquid crystal cell 7, which sides are opposite to the liquid crystal layer 14 in the liquid crystal cell 7, such that the liquid crystal cell 7 is sandwiched between the bottom polarizer 3 and the upper polarizer 4.

Further, phase difference films 8 and 9 (wave plates) are provided, as necessary, respectively (i) between the active matrix substrate 1 and the bottom polarizer 3, and (ii) between the color filter substrate 2 and the upper polarizer 4, in order that a viewing angle characteristic for displaying is improved. Note that either one of the phase difference films 8 and 9 may be provided on either one of surfaces of the liquid crystal cell 7. Alternatively, both of the phase difference films 8 and 9 may be provided, respectively on first and second surfaces of the liquid crystal cell, as illustrated in FIG. 14.

A respective of the phase difference films 8 and 9, and a respective of the bottom polarizer 3 and the upper polarizer 4 are bonded to the liquid crystal cell 7 via pressure sensitive adhesive layers 24.

In the present embodiment, the upper polarizer 4 indicates a polarizer that faces a display surface of the liquid crystal panel 10, and the bottom polarizer 3 indicates a polarizer facing a substrate provided on a surface of the liquid crystal panel 10, the surface being opposite to the display surface of the liquid crystal panel 10, that is, a polarizer that faces the backlight 20.

The bottom polarizer 3 and the upper polarizer 4 are arranged such that absorption axes (not shown) thereof are at right angles to each other.

The active matrix substrate 1 includes a gate bus line (not shown) and a source bus line 80 such that the gate bus line and the source bus line 80 are at right angles to each other, and a switching element (an active element) such as a TFT (Thin Film Transistor) 81 is provided at an intersection of the gate bus line and the source bus line 80.

The TFT 81 is arranged such that a gate electrode 83, a gate insulating film 84, a semiconductor layer 85, an amorphous silicon layer 86, a source electrode 87, and a drain electrode 88 are provided, sequentially in this order, on an insulating substrate 82 (a transparent substrate) such as a glass substrate, which is a base substrate. The TFT 81 may be covered with a BM (Black Matrix) 89 as necessary, as illustrated in FIG. 14.

As illustrated in FIG. 14, the gate electrode 83 of the TFT 81 is electrically connected to the gate bus line (not shown). Further, the source electrode 87 of the TFT 81 is electrically connected to the source bus line 80. Further, the drain electrode 88 of the TFT 81 is electrically connected to a pixel electrode 91 provided at each pixel via a contact hole (not shown) provided in an interlayer insulating layer 90 covering the insulating substrate 82. An alignment film 92 is provided on the pixel electrode 91.

On the other hand, the color filter substrate 2 is arranged such that a color filter layer 94, a counter electrode 95, and an alignment film 96 are provided on an insulating substrate (a transparent substrate) 93, in this order from the insulting substrate 93. The insulating substrate 93 is a glass substrate or the like and provided as a base substrate.

The pixel electrode 91 and the counter electrode 95 can be, for example, a transparent electrode made from ITO (Indium Thin Oxide) or the like. Further, the interlayer insulating film 90 can be, for example, an insulating film made from JAS or the like.

The foregoing arrangements of the active matrix substrate 1 and the color filter substrate 2 are just exemplary arrangements, and the present embodiment is not limited to the arrangements. Further, the insulating substrate 82 can be not only the glass substrate, but also a plastic substrate.

The backlight 20 is constituted, for example, by a plurality of discharge lamp tubes 22, such as cold cathode fluorescent tubes (CCFT), that are provided side by side, and a diffusing plate 23 is provided, as a light diffusing plate, on a side of the backlight 20 from which light is emitted.

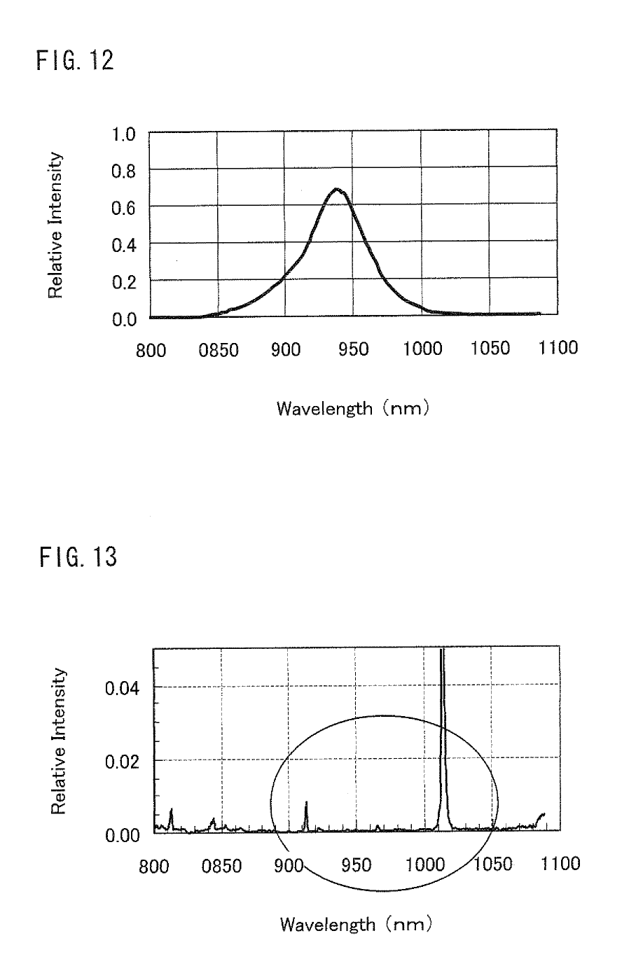

The discharge lamp tubes 22 contain, in tubes, inactive gas such as neon (Ne) and argon (Ar), and mercury (Hg). As shown in FIG. 12 that is an explanatory view of a conventional technique, the mercury (Hg) emits light in an infrared region, which light has a maximum relative intensity at a wavelength of 1015 nm, and the inactive gas emits light having a maximum relative intensity at a wavelength of 910 nm which is the infrared region.

In an electronic device such as a television, a remote controller is generally used for operating the device. Such the remote controller normally uses an infrared communication that uses a near-infrared (900 nm to 1100 nm) region. In this respect, in a case where an electronic device that uses the infrared communication by a remote controller is placed around a liquid crystal display device that emits light having near-infrared wavelengths from a backlight to its outside, the light having near-infrared wavelengths that is emitted from the liquid crystal display device comes, as a noise, into a receiving section (a signal receiving section) in the peripheral electronic device of the liquid crystal display device, which receiving section receives a signal from the remote controller. This causes a problem that the peripheral electronic device does not work, or the device is caused to malfunction.

In order to solve such a problem, in the present embodiment, the bottom polarizer 3 and the upper polarizer 4 have a function as a near-infrared region absorbing member that absorbs light in 900 nm through 1100 nm. Hereinafter, a region in which a wavelength is from 900 nm through 1100 nm is just referred to as a “near-infrared region”.

Generally, the bottom polarizer 3 and the upper polarizer 4 are made of a polyvinyl alcohol (PVA) film as a base material. The polyvinyl alcohol (PVA) film is (i) prepared so as to contain iodine (I) or a dichroic dye such as a dye compound by adsorbing or dyeing, and (ii) uniaxially drawn with high accuracy so as to be oriented. This causes the polyvinyl alcohol (PVA) film to have absorption anisotropy.

A transmittance of the iodine (I) is zero with respect to light having a wavelength of less than 750 nm as shown in FIG. 1, and the iodine absorbs visible light. From this reason, the bottom polarizer 3 and the upper polarizer 4 absorb lights parallel to respective absorption axes of the bottom polarizer 3 and the upper polarizer 4. Meanwhile, lights vertical to the respective absorption axes of the bottom polarizer 3 and the upper polarizer 4 pass through the bottom polarizer 3 and the upper polarizer 4.

However, in the absorption axes of the bottom polarizer 3 and the upper polarizer 4, each containing the iodine (I), the transmittance is not less than 1 with respect to light having a wavelength of not less than 750 nm as shown in FIG. 1. This means that light in the near-infrared region is hardly absorbed.

In this respect, in the present embodiment, the bottom polarizer 3 and the upper polarizer 4, each containing the iodine (I), are improved so as to absorb light in the near-infrared region.

More specifically, the polyvinyl alcohol (PVA) film as a base material of the bottom polarizer 3 and the upper polarizer 4 contains iodine and a dye that absorbs light in the near-infrared region.

That is, as shown in FIG. 1, light having a wavelength of less than 780 nm passes through the dye, whereas light having a wavelength of not less than 780 nm is absorbed by the dye. In other words, the dye selectively absorbs light in the near-infrared region and has a maximum relative absorption intensity (absorption maximum) in the near-infrared region.

As such the bottom polarizer 3 and the upper polarizer 4 of the present embodiment have both functions of (a) absorbing visible light due to the iodine (I) and (b) absorbing light in the near-infrared region due to the dye. That is, the absorption function of the dye makes up for the absorption function of the iodine (I) that cannot absorb light in the near-infrared region.

As the dye that absorbs the light in the near-infrared region, an organic matter having a conjugate double bond has been generally known. The organic matter is preferably a long-chain substance having plural conjugate double bonds, such as a substance having plural benzene rings. The organic matter may be, for example, a C10 to 30 dye, but is not limited to this.

Such the dye that absorbs the light in the near-infrared region is preferably a dye represented by the following Formula (1):

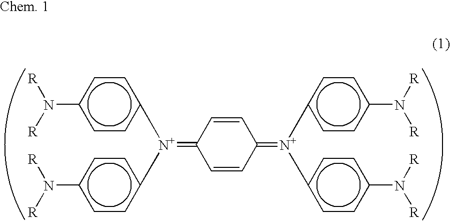

In the dye represented by Formula (1), parts where a respective of four benzene rings are bonded to ionized nitrogen control absorption, and the absorption is equivalent to those of dyes respectively represented by the following Formulae (2) and (3). In Formula (1), R corresponds to R₁ through R₈ in Formulae (2) and (3).

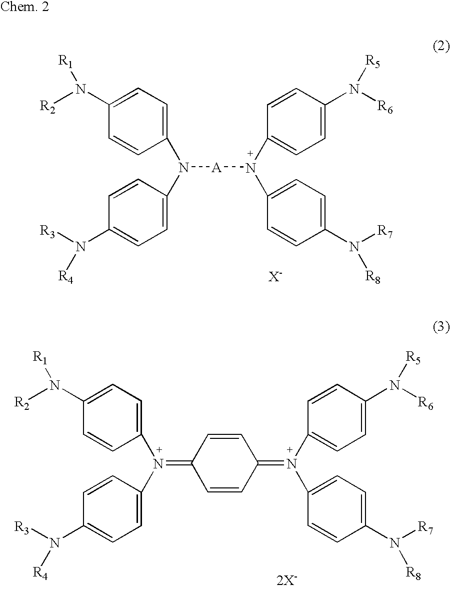

(wherein, in Formula (2), A is selected from a phenylene group and a biphenylene group; X represents an anion; and R₁ to R₈ independently represent a C1 to C8 substituent group, and at least one combination of R₁ and R₂, R₃ and R₄, R₅ and R₆, and R₇ and R₈ forms, together with N, a substituted or unsubstituted pyrrolidine ring, a substituted or unsubstituted piperidine ring, a substituted or unsubstituted morpholine ring, a substituted or unsubstituted tetrahydropyridine ring, or a substituted or unsubstituted cyclohexyl amine ring.)

In Formula (2), the meaning of “at least one combination of R₁ and R₂, R₃ and R₄, R₅ and R₆, and R₇ and R₈ forms, with N, a substituted or unsubstituted pyrrolidine ring, a substituted or unsubstituted piperidine ring, a substituted or unsubstituted morpholine ring, a substituted or unsubstituted tetrahydropyridine ring, or a substituted or unsubstituted cyclohexyl amine ring” is that at least one of a —NR₁R₂ group, a —NR₃R₄ group, a —NR₅R₆ group, and a —NR₇R₈ group forms any of the aforementioned rings.

Further, A in Formula (2) may be, for example, a 1,4-phenylene group, a 4,4′-biphenylene group, or the like.

The substituent groups represented by R₁ to R₈ are not limited provided that the substituent groups are an organic residual group, but may be, for example, a C1 to C8 straight or branched alkyl group, an acyl group having a carboxyl group, a hydroxyl group, an amino group, or the like.

Further, the anion is not especially limited, but may be, for example: a chloride ion, a bromide ion, an iodine ion, a perchlorate ion, a nitrate ion, a benzenesulfonate ion, a P-toluene sulfonate ion, a methylsulfate ion, an ethylsulfate ion, a propylsulfate ion, a tetrafluoroborate ion, a tetraphenyl borate ion, a hexafluorophosphate ion, a benzene sulfinate ion, an acetate ion, a trifluoroacetate ion, a propionate ion, a benzoate ion, an oxalate ion, a succinate ion, a malonate ion, an oleate ion, a stearate ion, a citrate ion, a monohydrogen diphosphate ion, a dihydrogen monophosphate ion, a pentachloro stannate ion, a chlorosulfonate ion, a fluorosulfonate ion, a trifluoromethane sulfonate ion, hexafluoro arsenate ion, a hexafluoro antimonate ion, a molybdate ion, a tungstate ion, a titanate ion, a zirconate ion, or the like.

Further, an aromatic ring at a center may be substituted with a lower alkyl group or a halogen group.

A near-infrared absorbing compound, represented by Formula 2 or 3, which absorbs light in the near-infrared region can be obtained by conducting selective alkylation of alkylating an amino compound obtained by an Ullmann reaction and a reduction reaction, followed by subjecting the resultant compound to an oxidation reaction, as disclosed in Patent Literature 4. Moreover, the dye represented by Formula 2 or 3 may be, for example, a near-infrared absorbing compound as disclosed in Patent Literature 4.

Other than these compounds, dyes made from, for example, phthalocyanine, nickel complex, azo compound, polymethine, diphenylmethane, triphenylmethane, quinone, and the like can be used. More specifically, dyes represented by the following Formulae (4) and (5) can be used.

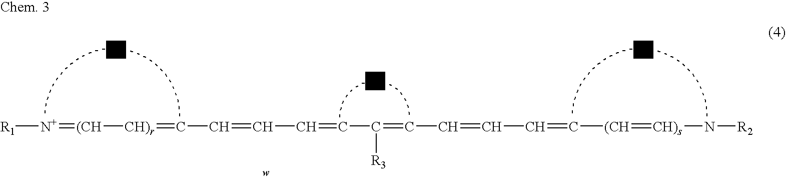

(wherein X₁ and X₂ independently represent an atom necessary to form a five- or six-membered heterocyclic nucleus including X₁ or X₂; X₃ represents an atom or a substituent group necessary to form a substituted or unsubstituted five- or six-membered cyclic structure; R₁ and R₂ are independently selected from a substituted or unsubstituted alkyl group and a substituted or unsubstituted aryl group; R₃ is selected from a hydrogen atom, a substituted or unsubstituted alkyl group, and a substituted or unsubstituted aryl group; r and s independently represent 0 or 1; and w represents at least one counter ion necessary to maintain molecular charge balance.)

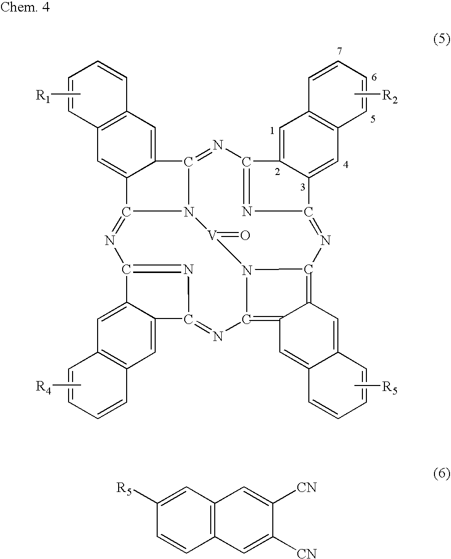

(wherein, in Formula (5), R₁ to R₄ represent a C5 straight or branched alkyl group, and in Formula (6), R₅ represents a C5 alkyl group.)

Note that, in Formula (4), alkyl groups represented by R₁, R₂, and R₃ encompass a C1 to C20 (preferably C1 to C10, further preferably C1 to C6) substituted or unsubstituted alkyl group that is chained, branched chain, or cyclic. The alkyl groups preferably encompass, for example, a methyl group, an ethyl group, a propyl group, a butyl group, an iso-butyl group, a t-butyl group, and the like.

Further, in Formula (4), aryl groups represented by R₁, R₂, and R₃ encompass a substituted or unsubstituted carbocyclic group and a substituted or unsubstituted heteroaryl group, each having four to seven (preferably five to six) carbon atoms and one to four hetero atoms selected from O, N, and S.

The carbocyclic group may be, for example, an aromatic group such as a phenyl group, a tolyl group, or a naphthyl group. Further, The heteroaryl group may be a pyridyl group, a thienyl group, a pyrrolyl group, a furyl group, or the like.

It is desirable that the dye represented by Formula (4) have at least two, preferably four, more preferably six to eight acid or acid salt groups. For example, it is preferable that X₁, X₂, X₃, R₁, and R₂ respectively have at least one acid or acid salt group.

The acid or acid salt groups encompass a carboxy group, a sulfa group, a phosphato group, a phosphono group, a sulfonamide group, a sulfamoyl group, and an acylsulfonamide group (for example, a —CH₂—CO—NH—SO₂—CH₃ group, and the like). The term “acid or acid salt group” is used to refer to a free acid group or its corresponding salt, and does not include ester where there is a unionizable or ionized proton.

Further, the substituent groups according to any of the specified groups including the groups described in relation to X₁, X₂, R₁, and R₂, may encompass: halogen (for example, chloro, fluoro, bromo, or iodine); an alkoxy group (especially a C1 to C10, preferably C1 to C6 alkoxy group such as a methoxy group or an ethoxy group); a substituted or unsubstituted alkyl group (especially a C1 to C10, preferably C1 to C6 alkyl group such as a methyl group or a trifluoromethyl group); an amide group or a carbamoyl group (especially a C1 to C10, preferably C1 to C6 amide group or carbamoyl group); an alkoxycarbonyl group (especially a C1 to C10, preferably C1 to C6 alkoxycarbonyl group); a substituted or unsubstituted aryl group (especially a C1 to C10, preferably C1 to C6 aryl group such as a phenyl group or a 5-chlorophenyl group); a heteroaryl group having a five- or six-membered ring including one to three hetero atoms selected from N, O, and S (for example, a pyridyl group, a thienyl group, a furyl group, a pyrrolyl group, or the like); an alkylthio group (especially a C1 to C10, preferably C1 to C6 alkylthio group such as a methylthio group or an ethylthio group); a hydroxy group or an alkenyl group (especially a C1 to C10, preferably C1 to C6 hydroxy group or alkenyl group); a cyano group; or other groups well known in the related field.

Additionally, rings formed by X₁ and X₂ may be further substituted.

Moreover, X₃ is not especially limited, but may be, for example, a —CH₂—CR₉R₁₀—CH₂— group. It is preferable that R₆ and R₇ be a substituted or unsubstituted alkyl group such as a methyl group, and R₃ be a hydrogen atom.

The counter ion is not especially limited, but may be, for example, sodium, potassium, p-toluene sulfonate, hydrotriethylammonium, or the like.

The dye (near-infrared absorbing compound) represented by Formula (4) may be, for example, a near-infrared absorbing compound (a near-infrared absorbing dye) disclosed in Patent Literature 5. Further, the near-infrared absorbing compound represented by Formula (4) can be obtained, for example, by a method disclosed in Patent Literature 5.

The dye (near-infrared absorbing compound) represented by Formula (5) may be, for example, a naphthalocyanine compound disclosed in Patent Literature 6. More specifically, the dye represented by Formula (5) may be, for example, a tetra-tert-amylvanadyl naphthalocyanine, or the like.

A method for producing the near-infrared absorbing compound represented by Formula (5) may be, for example, a method disclosed in Patent Literature 6 in which a 2,3-dicyanonaphthalene represented by Formula (6) and a vanadyl trichloride are superheated and reacted with each other in urea. Further, it is also possible to obtain the near-infrared absorbing compound represented by Formula (5), for example, by a method disclosed in Patent Literature 6.

With the use of the bottom polarizer 3 and the upper polarizer 4 containing any of the aforementioned near-infrared absorbing dyes, outgoing of light in the near-infrared region emitted from the liquid crystal panel 10 is prevented. With the arrangement, as shown in experimental results in after-mentioned Examples, it was observed that near-infrared light emitted from the backlight 20 could be shielded.

As such, the liquid crystal display device 30 of the present embodiment is such that a near-infrared region absorbing member(s) is(are) provided in the liquid crystal display device 30, more specifically, in the liquid crystal panel 10. This allows the liquid crystal panel 10 itself to have a function of absorbing light in the near-infrared region.

Especially, in the liquid crystal display device 30, the liquid crystal panel 10 includes a pair of polarizers, which sandwich the liquid crystal cell 7, i.e., the bottom polarizer 3 and the upper polarizer 4, and at least one of the pair of polarizers is a near-infrared region absorbing member.

As such, in the liquid crystal display device 30, the at least one of the pair of polarizers provided in the liquid crystal panel 10 that is an essential constituent for a liquid crystal device is a near-infrared region absorbing member. As a result, the near-infrared region absorbing member is not necessarily produced separately from the liquid crystal panel 10, thereby making it possible to provide the liquid crystal display device 30 that can shield the near-infrared light emitted from the backlight 20, without increasing the number of components.

Further, with the arrangement in which the near-infrared region absorbing members are the bottom polarizer 3 and the upper polarizer 4, it is possible to avoid the following problems: air comes into an interface when a display filter that absorbs near-infrared light is attached to the upper polarizer 4; a defective ratio increases, and the like problems. This makes it possible to increase a production yield and to reduce a production cost. Further, it is possible to avoid a decrease in display quality due to air coming into the interface, and the like problems.

In the present embodiment, both of the bottom polarizer 3 and the upper polarizer 4 are provided as near-infrared region absorbing members. However, the arrangement is not necessarily limited to this as has been already described, and such an arrangement is also possible in which either one of the bottom polarizer 3 and the upper polarizer 4 is a near-infrared region absorbing member. This is because even if either one of the bottom polarizer 3 and the upper polarizer 4 is a near-infrared region absorbing member, if light in the near-infrared region can be absorbed, then it is possible to prevent that the light in the near-infrared region leaks outside.

The inventers of the present invention diligently studied on this matter and found the followings. That is, even in a case where only the bottom polarizer 3 was the near-infrared region absorbing member, it was possible to sufficiently obtain the effect of the present invention. However, in a case where not only visible light but also the near-infrared light was polarized, if the upper polarizer 4 also had a function of absorbing the near-infrared light, it was possible to further increase the effect of the present invention.

In the liquid crystal display device 30 of the present embodiment, it is preferable that the near-infrared region absorbing member have an absorptance of not less than 30% with respect to light in the near-infrared region.

With the arrangement, since the near-infrared absorbing member is provided in the liquid crystal panel 10, even if light having a wavelength in the near-infrared region is emitted from the backlight 20, at least 30% of the light is absorbed. This makes it possible to prevent that a peripheral electronic device of the liquid crystal display device 30 malfunctions due to the light having a wavelength in the near-infrared region, emitted from the backlight 20, when the peripheral electronic device is operated by use of a remote control.

Further, as shown in experimental results of after-mentioned Examples, since the near-infrared region absorbing member has an absorptance of not less than 30% with respect to the light in the near-infrared region, it is possible to obtain an effect to prevent the malfunctions of the peripheral electronic device that uses the infrared communication with a remote controller.

Further, in the liquid crystal display device 30 of the present embodiment, it is preferable that at least one of the bottom polarizer 3 and the upper polarizer 4 be made from a material containing iodine and a dye that absorbs light in the near-infrared region.

That is, from the viewpoint of contrast, a polarizer is generally made from iodine. However, in the present embodiment, in addition to the iodine, a dye that absorbs light in the near-infrared region is added. The iodine has absorbability with respect to visible light. However, when the iodine is drawn so as to be oriented, this causes the iodine to have a lattice-shaped part having a characteristic of absorbing visible light and a blank space part having a characteristic of passing visible light therethrough. In this regard, in the present embodiment, the lattice-shaped part having the characteristic of absorbing visible light also absorbs the light in the near-infrared region.

From this reason, with the arrangement in which the near-infrared region absorbing member is at least one of the bottom polarizer 3 and, the upper polarizer 4 that are made from a material containing the iodine and the dye that absorbs light in the near-infrared region, it is possible to realize the liquid crystal display device 30 that can shield near-infrared light emitted from the backlight 20, without decreasing a display quality.

In the present embodiment, a thickness of the near-infrared region absorbing member is not especially limited, and may be set as appropriate so as to obtain an intended absorptance with respect to the light in the near-infrared region. However, the thickness is preferably not more than 1000 μm from a viewpoint of stability in strength. Note however that the thickness is preferably at least around a few μm for mixing the dye into the material.

Further, a content of the dye in the near-infrared absorbing member is not limited, and may be set as appropriate so as to obtain an intended absorptance with respect to the light in the near-infrared region. In a case where the near-infrared region absorbing members are both the upper polarizer 4 and the bottom polarizer 3, respective contents of the iodine and the dye in each of the near-infrared region absorbing members are not especially limited, provided that the iodine is contained more than the dye. However, it is preferable that the iodine be contained by not less than 90% (but not more than 100%) with respect to a total amount of the iodine and the dye.

Moreover, in the case where both the upper polarizer 4 and the bottom polarizer 3 are the near-infrared region absorbing members, it may not be a big problem whether or not the upper polarizer 4 and the bottom polarizer 3 contain the same or different amounts of a respective of the iodine and the dye.

Note that in such the case where both the upper polarizer 4 and the bottom polarizer 3 are the near-infrared region absorbing members, the bottom polarizer 3 mainly absorbs the light in the near-infrared region, and the upper polarizer 4 works supplementarily.

Moreover, in the liquid crystal display device 30 of the present embodiment, it is preferable that the dye have a plurality of conjugate double bonds, as has been already described.

Since a conjugate double bond is capable of absorbing the light in the near-infrared region, the inclusion of the plurality of conjugate double bonds improves absorbability of the light in the near-infrared region.

Furthermore, in the liquid crystal display device 30 of the present embodiment, the backlight 20 includes a light source constituted by the discharge lamp tubes 22.

The backlight 20 constituted by the discharge lamp tubes 22 emits light in the near-infrared region from inactive gas such as neon (Ne) and argon (Ar), and mercury (Hg).

However, with the above arrangement, it is possible to shield such the near-infrared light emitted from the backlight 20.

In the present embodiment and the after-mentioned embodiments, the polarized light reflecting sheet 13 has a thickness of 0.4 mm and the diffusing plate has a thickness of 2.0 mm. However, the values are just one example, and the present embodiment and the after-mentioned embodiments are not limited to these.

Further, the present embodiment describes an example in which the near-infrared region absorbing members are provided in the liquid crystal panel 10 such that the bottom polarizer 3 and the upper polarizer 4 are provided with a function as the near-infrared region absorbing member. However, the present embodiment is not limited to this.

In such a case where a near-infrared region absorbing member is provided in the liquid crystal panel 10, the near-infrared region absorbing member may be either one of the bottom polarizer 3 and the upper polarizer 4, as described above, or may be one of the pair of substrates (in the present embodiment, the active matrix substrate 1 and the color filter substrate 2) which one faces the backlight 20, the pair of substrates sandwiching the liquid crystal layer 14 therebetween. In a case where an optical member other than the bottom polarizer 3 and the upper polarizer 4, such as the phase different film 8, is provided so as to face the substrate that faces the backlight 20, the optical member such as the phase different film 8 may be provided with a function as the near-infrared region absorbing member. Otherwise, a pressure sensitive adhesive layer 24 for use in bonding the optical members including the bottom polarizer 3, which optical members face the substrate that faces the backlight 20, may be provided with a function as the near-infrared region absorbing member.

As such, when at least one of the members (components) fundamentally included in the liquid crystal panel 10 is the near-infrared region absorbing member, it is possible (i) to shield near-infrared light emitted from the backlight 20 without increasing the number of components, (ii) to improve a production yield compared with a conventional product, and (iii) to avoid a decrease in display quality.

In a case where a near-infrared region absorbing member is provided in the liquid crystal panel 10 such that the near-infrared region absorbing member is provided closer to a display surface than the liquid crystal layer 14 in the liquid crystal panel 10, it is necessary, as described above, that the near-infrared absorbing member be the upper polarizer 4, in order that the production yield is improved and the light in the near-infrared region is shielded without decreasing luminance and brightness. On the other hand, in a case where the near-infrared region absorbing member is provided closer to the backlight than the liquid crystal layer 14 in the liquid crystal panel 10, the near-infrared region absorbing member is not especially limited.

In a case where one of the pair of substrates that faces the backlight 20 is provided with a function as the near-infrared region absorbing member, the substrate that faces the backlight 20 is formed such that surfaces of an insulating substrate 82 made from glass, plastic, or the like, switching elements such as the TFTs 81, transparent electrodes (for example, the pixel electrodes 81) made from ITO or the like, and an insulating film (for example, the interlayer insulating film 90) made from JAS or the like are coated with a near-infrared region absorbing material containing the dye. Alternatively, the dye is mixed in materials of them other than the glass. This allows the substrate to have the function as the near-infrared region absorbing member.

Furthermore, in a case where an optical film such as a phase different film or the pressure sensitive adhesive layer is provided with a function as the near-infrared absorbing member, the dye is mixed in materials of them. This easily allows the materials to have the function as the near-infrared absorbing member.

In this way, in the case where a near-infrared region absorbing member is provided in the liquid crystal panel 10, the near-infrared region absorbing member in the liquid crystal panel 10 may be at least one of (1) the upper polarizer 4 of the pair of polarizers that faces the display surface, (2) one of the pair of substrates (the active matrix substrate 1 in the present embodiment, to be exact, at least one of constituents of the substrate) that faces the backlight 20, (3) the bottom polarizer 3 or the optical member such as the phase different film 8 provided as necessary, each provided so as to face an external surface of the substrate that faces the backlight 20, which surface is opposite to an internal surface of the substrate that faces the liquid crystal layer 14, and (4) the pressure sensitive adhesive layer 24 for adhering the optical member. This makes it possible to obtain the effect of the present invention.

### Embodiment 2

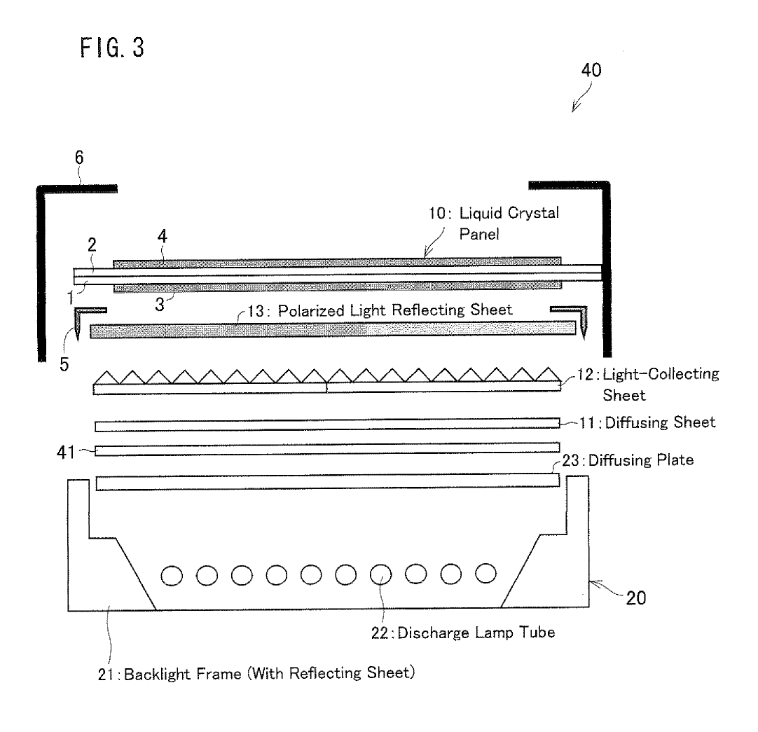

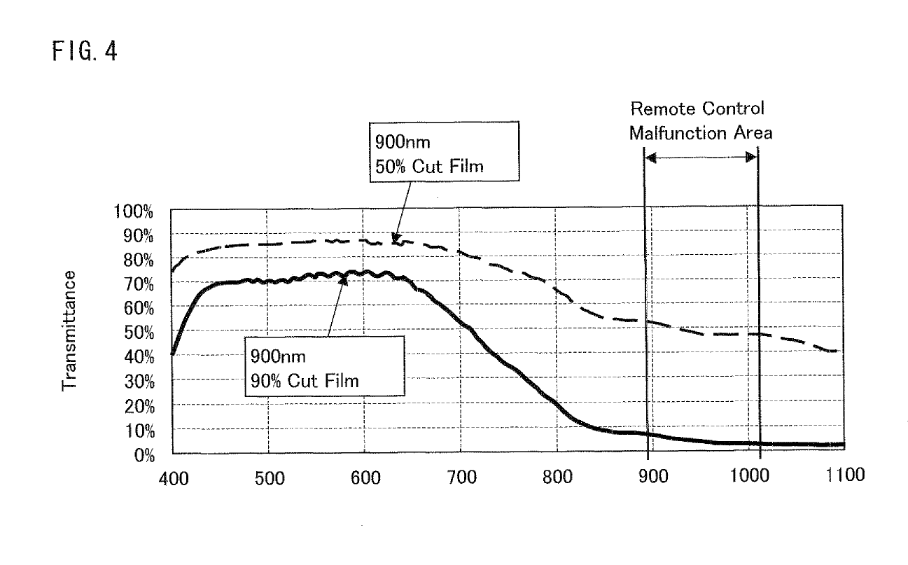

Another embodiment of the present invention is described with reference to FIGS. 3 through 5. In the present embodiment, arrangements other than the arrangement to be explained here are the same as those explained in Embodiment 1. Further, for the sake of convenience, members having the same functions as the members explained in drawings for Embodiment 1 respectively have the same reference signs and are not explained here.

A liquid crystal display device 40 in the present embodiment is arranged such that a polarizer having the same function as the bottom polarizer 3 and the upper polarizer 4 used in Embodiment 1 is provided between a backlight 20 and a liquid crystal panel 10.

As illustrated in FIG. 3, the liquid crystal display device 40 of the present embodiment is, for example, such that a near-infrared absorbing polarizer 41 as a near-infrared region absorbing polarizer is provided between a diffusing plate 23 of the backlight 20 and a diffusing sheet 11. The near-infrared absorbing polarizer 41 has the same functions as a bottom polarizer 3 and an upper polarizer 4, that is, has a function of absorbing visible light due to iodine (I) and a function of absorbing light in a near-infrared region due to a dye. A transmission axis of the near-infrared absorbing polarizer 41 is parallel to that of the bottom polarizer 3.

With respect to the arrangement, check tests were conducted with the use of the following films: (i) a film that absorbs 90% of near-infrared light having a wavelength of 900 nm (90% cut film for 900 nm), (ii) a film that absorbs 50% of the near-infrared light having the wavelength of 900 nm (50% cut film for 900 nm), and (iii) a film that absorbs 30% of the near-infrared light having the wavelength of 900 nm (30% cut film for 900 nm, not shown), each used in the near-infrared absorbing polarizer 41. As results of the tests, it was demonstrated that the above arrangement had an effect to avoid a problem that a peripheral electronic device of the liquid crystal panel did not work, or was caused to malfunction when the device was operated by a remote controller. Such a problem is caused because light having a wavelength in the near-infrared region affects, as a noise, a receiving section (a signal receiving section) of the peripheral electronic device, which section receives a signal transmitted from the remote controller, in other words, the noise comes into the receiving section.

From the viewpoint of the function of absorbing near-infrared, the near-infrared absorbing polarizer 41 may be provided (i) between a diffusing plate 23 and a diffusing sheet 11, (ii) between the diffusing sheet 11 and a light-collecting sheet 12, or (iii) between the light-collecting sheet 12 and a polarized light reflecting sheet 13, each provided between the backlight 20 and the liquid crystal panel 10.

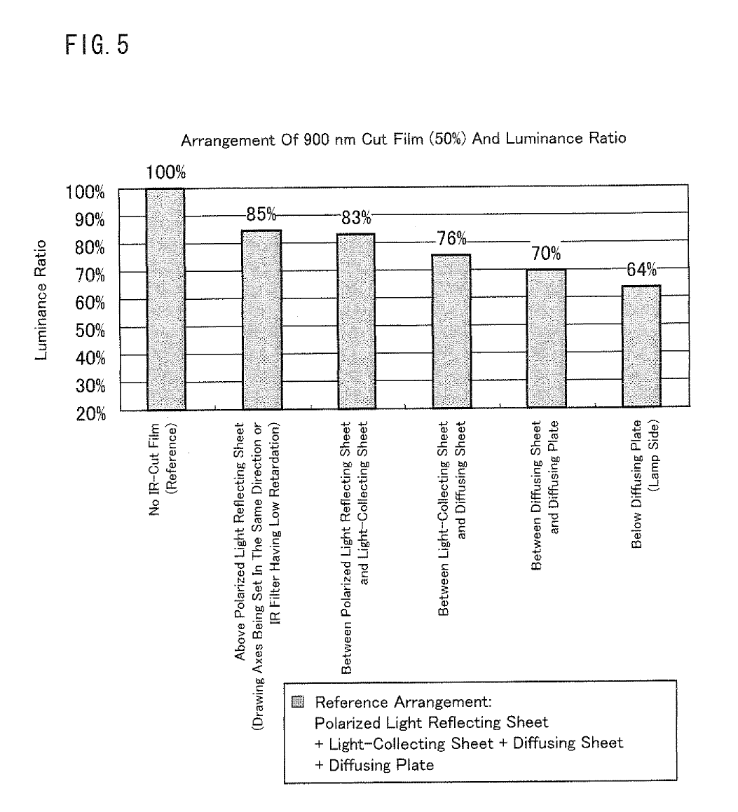

In this case, as shown in FIG. 5, it was demonstrated that luminance decreased as the near-infrared absorbing polarizer 41 was provided closer to the backlight 20.

That is, as has been described, in a case where a polarizer is provided as a near-infrared absorbing member, that is, the bottom polarizer 3 and the upper polarizer 4 are provided, as the near-infrared absorbing polarizers, on front and back surfaces of the liquid crystal cell 7, it is possible to effectively restrain a decrease in luminance. On the other hand, in a case where the near-infrared absorbing member is provided between the liquid crystal panel 10 and the backlight 20, that is, the near-infrared absorbing member is provided closer to the backlight 20 than the bottom polarizer 3, it is preferable that a near-infrared absorbing polarizer (the near-infrared absorbing polarizer 41) be provided, as the near-infrared absorbing member, as close to the bottom polarizer 3 as possible in view of restraining the decrease in luminance.

On this account, from the viewpoint of preventing the decrease in luminance, the near-infrared absorbing polarizer 41 is provided more preferably at least (i) between the liquid crystal panel 10 and the polarized light reflecting sheet 13 or (ii) between the light-collecting sheet 12 and the polarized light reflecting sheet 13, especially preferably between the liquid crystal panel 10 and the polarized light reflecting sheet 13.

As such, in the liquid crystal display device 40 of the present embodiment, at least one sheet-like and plate-like optical member is provided between the backlight 20 and the liquid crystal panel 10, and at least one of the at least one optical member is a near-infrared region absorbing member. This makes it possible that the near-infrared region absorbing member is provided between the backlight 20 and the liquid crystal panel 10, not in the liquid crystal panel 10 itself. The term “sheet-like” indicates a relatively thin form having no stiffness, and the term “plate-like” indicates a form having a thickness and stiffness. A specific thickness of the optical member is not limited, and it is not a big problem whether the optical member is in a sheet-like form or a plate-like form.

Further, the liquid crystal display device 40 of the present embodiment can be arranged as follows. The backlight 20 including the diffusing plate 23 is provided on a backside of the liquid crystal panel 10 including the liquid crystal cell 7 sandwiched between a pair of the bottom polarizer 3 and the upper polarizer 4. A near-infrared region absorbing member is the near-infrared absorbing polarizer 41 that is made from a material containing iodine and a dye that absorbs light in the near-infrared region, which near-infrared absorbing polarizer 41 is provided between the liquid crystal panel 10 and the diffusing plate 23 of the backlight 20.

In other words, the near-infrared region absorbing member is not necessarily the pair of the bottom polarizer 3 and the upper polarizer 4, which sandwich the liquid crystal cell 7 therebetween, but can be provided between the liquid crystal panel 10 and the diffusing plate 23 of the backlight 20. In this case, it is better that the near-infrared region absorbing member is provided as a polarizer which is made from the material containing iodine and the dye that absorbs the light in the near-infrared region and which has a function of absorbing light in the near-infrared region.

This makes it possible to provide the liquid crystal display device 40 that can shield near-infrared light emitted from the backlight without decreasing a display quality.

Additionally, in the liquid crystal display device 40 of the present embodiment, it is preferable that the dye have a plurality of conjugate double bonds. Since a conjugate double bond is capable of absorbing light in the near-infrared region, the inclusion of the plurality of conjugate double bonds improves absorbability of the light in the near-infrared region.

Furthermore, in the liquid crystal display device 40 of the present embodiment, the diffusing sheet 11, the light-collecting sheet 12, and the polarized light reflecting sheet 13 are provided in this order from the diffusing plate 23, between the diffusing plate 23 of the backlight 20 and the liquid crystal panel 10. In this case, it is possible to provide the near-infrared absorbing polarizer 41 as the near-infrared region absorbing member at least (i) between the diffusing plate 23 and the diffusing sheet 11, (ii) between the diffusing sheet 11 and the light-collecting sheet 12, or (iii) between the light-collecting sheet 12 and the polarized light reflecting sheet 13. This makes it possible to shield the near-infrared light emitted from the backlight 20.

Further, in the liquid crystal display device 40 of the present embodiment, the backlight 20 is constituted by discharge lamp tubes 22.

The backlight 20 constituted by the discharge lamp tubes 22 emits light in the near-infrared region from inactive gas such as neon (Ne) and argon (Ar), and mercury (Hg). However, with the above arrangement, it is possible to shield such the near-infrared light emitted from the backlight 20.

In the present embodiment, the near-infrared absorbing polarizer 41 is provided at least (i) between the diffusing plate 23 and the diffusing sheet 11, (ii) between the diffusing sheet and the light-collecting sheet 12, or (iii) between the light-collecting sheet 12 and the polarized light reflecting sheet 13. However, a position where the near-infrared absorbing polarizer 41 is provided is not limited to the above.

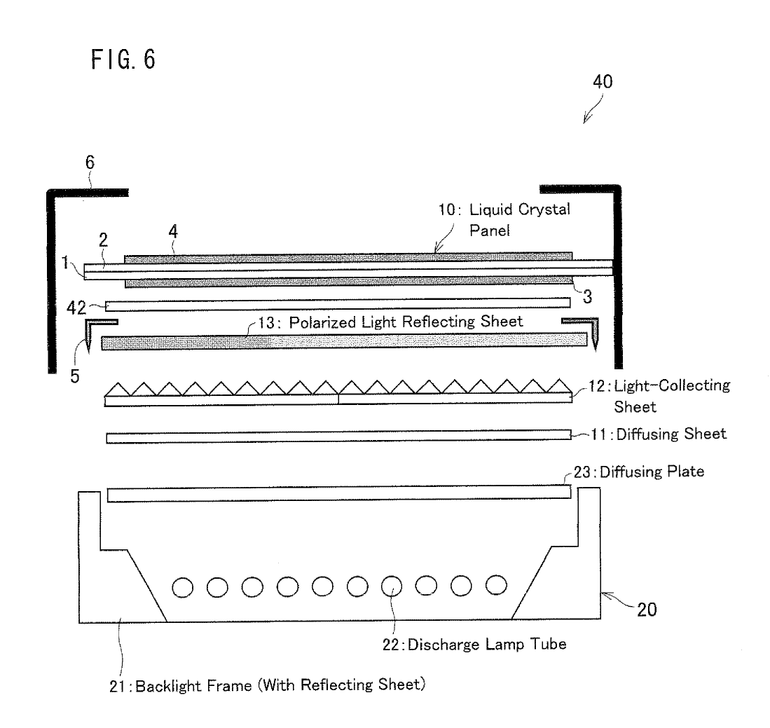

For example, as illustrated in FIG. 6, a near-infrared absorbing polarizer 42 can be provided, as a near-infrared region absorbing member having the same function as the near-infrared absorbing polarizer 41, between the polarized light reflecting sheet 13 and the liquid crystal panel 10. In this case, it is preferable that a retardation Δn·d satisfy Δn·d<100 nm.

To put it differently, in a case where the near-infrared absorbing polarizer 42 is positioned above the polarized light reflecting sheet 13, it is necessary that the near-infrared absorbing polarizer 42 have a low retardation. A wavelength of visible light is from 380 nm to 780 nm. A maximum luminance is obtained at a center wavelength (about 500 nm) of the visible light. When the light having the center wavelength is twisted, the luminance decreases, that is, the luminance depends on the center wavelength of the visible light. On this account, in order that polarized light in the visible light region is not to be disturbed, it is preferable that the retardation Δn·d of the near-infrared absorbing polarizer 42 be at least one order of magnitude lower than the center wavelength (about 500 nm) of the visible light. From this reason, when the retardation Δn·d of the near-infrared absorbing polarizer 42 is set less than 100 nm, it is possible to attain the arrangement that can prevent the decrease in luminance.

Further, in the liquid crystal display device 40 of the present embodiment, it is preferable that a base material of the near-infrared absorbing polarizer 42 be made from polycarbonate (PC), olefin resin such as polyethylene terephthalate (PET), or triacetyl cellulose (TAC).

These materials easily attain a low retardation of the near-infrared absorbing polarizer 42.

Moreover, in the liquid crystal display device 40 of the present embodiment, it is preferable that the diffusing sheet 11, the light-collecting sheet 12, and the polarized light reflecting sheet 13 be provided in this order from the diffusing plate 23, between the diffusing plate 23 of the backlight 20 and the liquid crystal panel 10. Further, it is preferable that the near-infrared absorbing polarizer 42 be provided between the polarized light reflecting sheet 13 and the liquid crystal panel 10 such that either a long axis or a short axis of an index ellipsoid of the base material (made from PC, PET, TAC, or the like) of the near-infrared absorbing polarizer 42 is parallel to an absorption axis or a transmission axis of the bottom polarizer 3 and the upper polarizer 4 of the liquid crystal panel 10.

When drawing axes of the constituent members are set in the same direction as such, it is possible to obtain the same effect as the low retardation.

Further, according to the present embodiment, the near-infrared region absorbing members are provided in the liquid crystal display panel and between the liquid crystal panel and the backlight. From this reason, it is not necessary that the near-infrared, region absorbing members be attached to the liquid crystal panel by use of an adhesive material (a pressure sensitive adhesive material). With the arrangement, even if either one of the near-infrared region absorbing members and an other constituent member (for example, the liquid crystal panel) of the liquid crystal display device 40 has a defect, it is possible to easily replace the defective member without detaching the near-infrared region absorbing members. On this account, it is possible to provide, at a low production cost, a liquid crystal display device which can shield near-infrared light, and which has a relatively high production yield compared with a case where a display filter is attached to a display screen.

Moreover, since the near-infrared region absorbing member is provided closer to the backlight than the liquid crystal panel, it is not necessary to attach the near-infrared region absorbing member to the liquid crystal panel by use of an adhesive material (a pressure sensitive adhesive material), thereby resulting in that a decrease in display quality due to air coming into an interface or the like problem can be prevented. In addition, even if either one of the liquid crystal panel and the near-infrared region absorbing member has a defect, the defective one can be easily replaced. As a result, it is possible to provide, at a low production cost, a liquid crystal display device which can shield near-infrared light, and which has a high production yield compared with the case where a display filter is attached to a display screen.

The present embodiment describes an exemplary case where the near-infrared region absorbing member is provided between the liquid crystal panel 10 and the backlight 20. However, the present embodiment is not limited to the arrangement. The near-infrared region absorbing member may be provided at least either in the liquid crystal panel or between the liquid crystal panel and the backlight. Further, the near-infrared region absorbing member may not be a polarizer.

### Embodiment 3

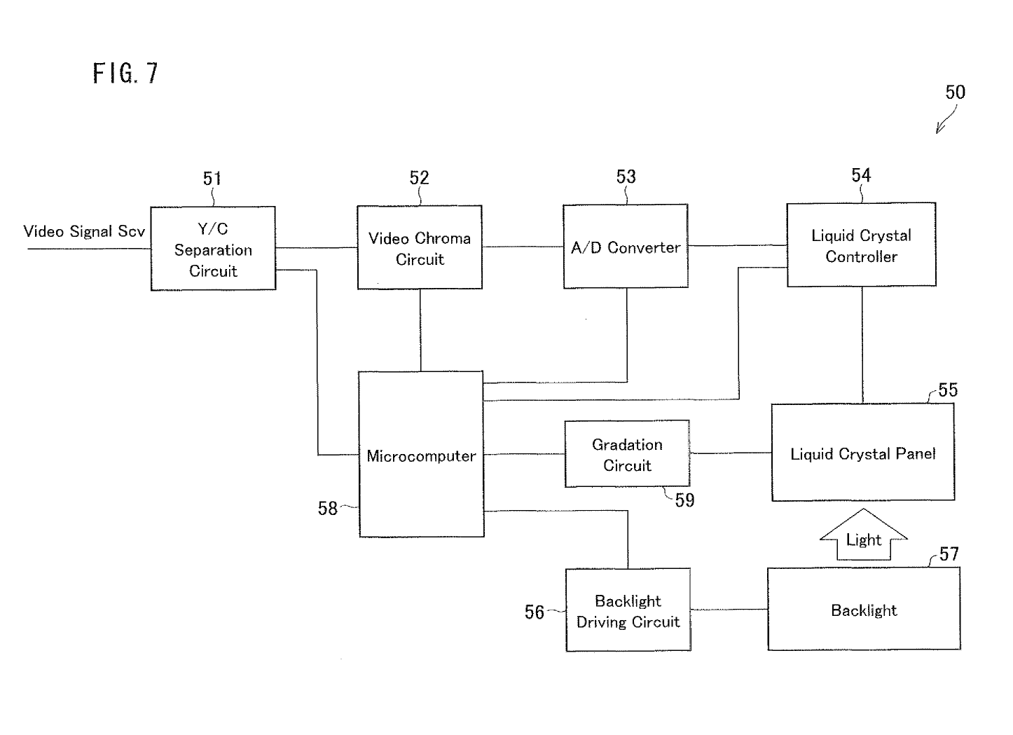

Another embodiment of the present invention is described below with reference to FIGS. 7 through 9. In the present embodiment, arrangements other than the arrangement to be explained here are the same as those explained in Embodiments 1 and 2. Further, for the sake of convenience, members having the same functions as the members explained in drawings for Embodiments 1 and 2 respectively have the same reference signs and are not explained here.

Explained in the present embodiment are a liquid crystal display device 50 that has a function equivalent to the liquid crystal display devices 30 and 40 of Embodiments 1 and 2, and a television receiver 60 including the liquid crystal display device 50.

FIG. 7 is a block diagram illustrating the liquid crystal display device 50 for receiving television.

As illustrated in FIG. 7, the liquid crystal display device 50 includes a Y/C separation circuit 51, a video chroma circuit 52, an A/D converter 53, a liquid crystal controller 54, a liquid crystal panel 55, a backlight driving circuit 56, a backlight 57, a microcomputer 58, and a gradation circuit 59.

The liquid crystal panel 55 includes a display section, a source driver, and a gate driver, each of the drivers for driving the display section.

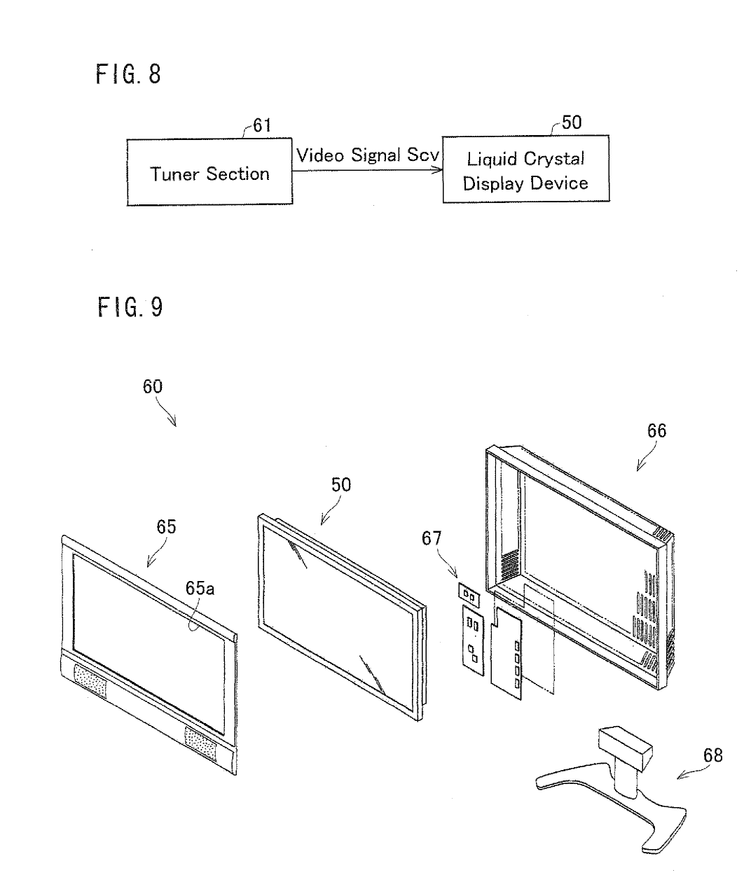

In the arrangement of the liquid crystal display device 50, a composite color video signal (Scv, referred to just a “video signal (Scv)” in FIGS. 7 and 8) is supplied from an external section to the Y/C separation circuit 51, and is separated into a luminance signal and a color signal. The video chroma circuit 52 converts the luminance signal and the color signal to analogue RGB signals of red (R), green (G), and blue (B), which are light's three primary colors. Then, the A/D converter 53 converts the analogue RGB signals to digital RGB signals. The digital RGB signals are supplied to the liquid crystal controller 54. The Y/C separation circuit 51 also picks up a horizontal vertical sync signal and a vertical sync signal from the composite color video signal (Scv) supplied from the external section, and these sync signals are also supplied to the liquid controller 54 via the microcomputer 58.

The liquid crystal controller 54 supplies the digital RGB signals and a timing signal based on the sync signals to the liquid crystal panel 55 at predetermined timing. Further, the gradation circuit 59 generates gradation voltages respectively for red (R), green (G), and blue (B), which are three primary colors for a color display, and also supplies the gradation voltages to the liquid crystal panel 55. Then, in the liquid crystal panel 55, the source driver, the gate driver, and the like, each provided in the liquid crystal panel 55, generate driving signals (a data signal, a scanning signal, and, the like signals) based on the RGB signals, the timing signal, and the generation voltages, and the display section (with an active matrix substrate) provided in the liquid crystal panel 55 carries out displaying of a color image based on the driving signals. In order that the liquid crystal panel 55 carries out the displaying of the image, it is required that the liquid crystal panel 55 be illuminated from its backside. In this regard, the liquid crystal display device 50 is arranged such that the backlight driving circuit 56 drives the backlight 57 in accordance with a control by the microcomputer 58 so that a back surface of the liquid crystal panel 55 is illuminated.

The microcomputer 58 controls an entire system including the above processes. The video signal (the composite color video signal) supplied from the external section is not only a video signal based on television broadcasting but also a video signal taken by a camera, a video signal provided via an internee line, and the like. As such the liquid crystal display device 50 can carry out displaying of various images based on various video signals.

In a case where the liquid crystal display device 50 carries out displaying of an image based on television broadcasting, a tuner section 61 is connected to the liquid crystal display device 50, as illustrated in FIG. 8. The tuner section 61 (i) selects a signal of an intended channel to be received, from receiving waves of high frequency signals received by antenna (not shown), (ii) converts the signal to an intermediate frequency signal, and (iii) detects the intermediate frequency signal so as to pick up a composite color video signal (Scv) as a television signal. Then, as has been already described, the composite color video signal (Scv) is supplied to the liquid crystal display device 50, and an image based on the composite color video signal (Scv) is displayed by the liquid crystal display device 50.

FIG. 9 is an exploded perspective view illustrating an example of a mechanical arrangement in which the liquid crystal display device 50 of the aforementioned arrangement is used in a television receiver 60. In the example illustrated in FIG. 9, the television receiver 60 includes, as its constituent components other than the liquid crystal display device 50, a first housing 65, and a second housing 66. The television receiver 60 is arranged such that the liquid crystal display device 50 is sandwiched between the first housing 65 and the second housing 66 so that the liquid crystal display device 50 is contained within the housings. The first housing 65 includes an opening 65a which passes an image displayed by the liquid crystal display device 50 therethrough. Further, the second housing 66 is for covering a backside of the liquid crystal display device 50, and includes an operation circuit for operating the liquid crystal display device 50. A support member 68 is attached to a bottom of the second housing 66.

As such, the television receiver 60 of the present embodiment includes the liquid crystal display device 50 and the tuner section 61 for receiving television broadcasting.

The arrangement makes it possible to provide the television receiver 60 including the liquid crystal display device 50 that can shield near-infrared light emitted from the backlight 57 without decreasing a display quality.

The present invention is not limited to the description of the embodiments above, but may be altered by a skilled person within the scope of the claims. An embodiment based on a proper combination of technical means disclosed in different embodiments is encompassed in the technical scope of the present invention.

### EXAMPLES

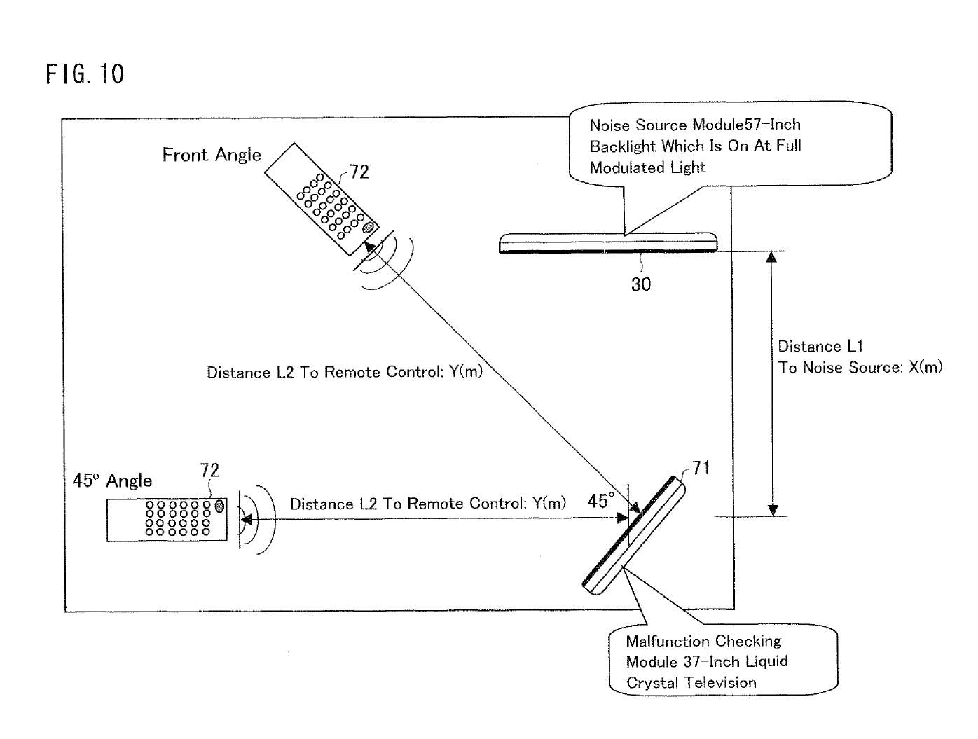

In the present examples, experiments were conducted for checking malfunctions in a peripheral electronic device of a liquid crystal display device that was a noise source, the malfunctions being caused due to a remote controller. FIG. 10 illustrates an experimental arrangement.

As illustrated in FIG. 10, the liquid crystal display device as a noise source used in the present examples was a liquid crystal television including a 57-inch liquid crystal display device 30 that included an IR-CUT filter as the aforementioned near-infrared region absorbing member. A malfunction checking module (an object to malfunction) was, as an example, a liquid crystal television including a 37-inch liquid crystal display device 71. No near-infrared region absorbing member was not provided in the 37-inch liquid crystal display device 71, in order to check how near-infrared light emitted from the 57-inch liquid crystal display device 30 as a noise source affected a receiving section (a signal receiving section) of the 37-inch liquid crystal display device 71, the receiving section being for receiving a signal transmitted from a remote controller 72 for the liquid crystal display device 71.

The following experiments were conducted such that a distance L1 between (i) the 37-inch liquid crystal display device 71 as an object to malfunction and (ii) a backlight 20 in the 57-inch liquid crystal display device 30 as a noise source was changed and an absorptance of the near-infrared region absorbing member with respect to light in the near-infrared region was also changed. The distance L1 was set 0 m, 1 m, 2 m, and 2.5 m. Further, the experiments were conducted such that a distance L2 between (i) the 37-inch liquid crystal display device 71 as an object to malfunction and (ii) the remote controller 72 that operates the 37-inch liquid crystal display 71 was changed depending on each of the distances L1.

As such, based on those distances to the 37-inch liquid crystal display device 71 as an object to malfunction (i) from the remote controller 72 from which a signal was supplied and (ii) from the 57-inch liquid crystal display device 30 from which a noise was generated, the experiments were conducted to find out a normal operation distance with respect to each of near-infrared absorptances of near-infrared region absorbing members. The normal operation distance denotes a distance in which the liquid crystal display device 71 is normally operated by the remote controller 72.

Further, the remote controller 72 was set so as to face the 37-inch liquid crystal display device 71 from a front angle or at 45°. Moreover, the experiments were evaluated at −10° C. at which a noise easily occurred.

The absorptance, with respect to light in the near-infrared region, of the near-infrared region absorbing member provided in the 57-inch liquid crystal display device 30 was measured by use of a spectral apparatus.

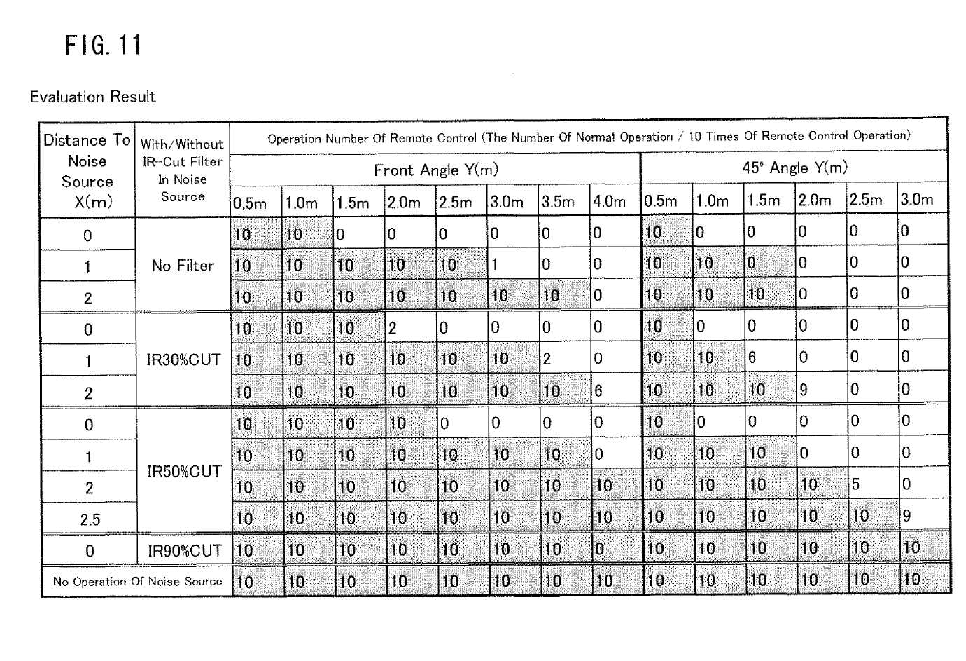

Evaluation results of the experiments are shown in FIG. 11. Shade regions in FIG. 11 indicate that the 37-inch liquid crystal display device was normally operated ten times out of ten remote control operations. In FIG. 11, data of a near-infrared absorptance of 30% (a case where the infrared region absorbing member had an absorptance of 30% with respect to light in the near-infrared region) indicated by “IR30% CUT” was obtained from a proportional calculation of (i) data of a near-infrared absorptance of 0% (a case where no infrared region absorbing member is provided) indicated by “no filter” in FIG. 11 and (ii) data of a near-infrared absorptance of 50% (a case where the infrared absorbing member had an absorptance of 50% with respect to the light in the near-infrared region) indicated by “IR50% CUT” in FIG. 11.

As a result of the experiments, it was demonstrated that absorption with the near-infrared absorptance of around 30% (i) allowed an operation distance, in which a normal operation could be carried out, to be little longer compared with a case where no IR-CUT filter was provided in the noise source, and (ii) could reduce the number of malfunctions. The operation distance is a distance in which the signal receiving section receives a signal without being affected by the noise, the signal receiving section being for receiving a signal from the remote controller 72.

Further, it was demonstrated that absorption with the near-infrared absorptance of around 50% allowed the operation distance, in which a normal operation could be carried out, to be 1 m to 2 m longer compared with the case where no IR-CUT filter was provided in the noise source.

Generally, in most cases, a liquid crystal display device as a noise source and a peripheral device of the liquid crystal display device, which peripheral device is to be caused to malfunction, are placed with a distanced space of at least one tatami mat via noise reflection from a wall or the like. A long side of the one tatami mat is 1.8 m. In the case of the near-infrared absorptance of 50%, when the distanced space is not less than 2 m, it is possible to obtain a state substantially equivalent to a state in which no noise source is placed around the peripheral device. As a result, in the case where the absorptance is 50% with respect to light in the near-infrared region, it is possible that the peripheral device hardly causes malfunctions.

Further, as shown in the “IR90% CUT” in FIG. 11, it was demonstrated that absorption with the near-infrared absorptance of around 90% (that is, absorption equivalent to the case where the infrared region absorbing member absorbs 90% of light in the near-infrared region) attained an effect substantially equal to a state in which the backlight 20 was turned off in the 57-inch liquid crystal display device 30 as a noise source, regardless of where the peripheral device was placed.

The present invention and the present embodiments focus on solving a problem that a module as a noise source affects and causes other devices to malfunction. In this regard, the present examples (experiments) were conducted with the use of the 37-inch liquid crystal display device 71 as an object to malfunction because such malfunctions can be easily checked with eyes. With the experiments, it is possible to easily find out how the backlight 20 in the 57-inch liquid crystal display device as a noise source affects and causes the 37-inch liquid crystal display device 30 to malfunction. However, the object to malfunction is not necessarily a liquid crystal display device or a television. Even if such an operation check is carried out, for example, with respect to a DVD (Digital Versatile Disc) player, the similar result can be obtained.

As described above, a liquid crystal display device of the present invention includes: (I) a liquid crystal panel including (i) a pair of substrates, which sandwich a liquid crystal layer therebetween, and (ii) optical members each provided so as to face an external surface of each of the pair of substrates, which surface is opposite to an internal surface of the each of the pair of substrates that faces the liquid crystal layer, the optical members each including a polarizer in pair; and (II) a backlight provided so as to face a surface of the liquid crystal panel, the surface being opposite to a display surface of the liquid crystal panel. The liquid crystal display device further includes a near-infrared region absorbing member that absorbs light in a near-infrared region of 900 nm to 1000 nm, and the near-infrared region absorbing member is provided at least either in the liquid crystal panel or between the liquid crystal panel and the backlight. In a case where the near-infrared region absorbing member is provided in the liquid crystal panel, the near-infrared region absorbing member in the liquid crystal panel is at least one of the following members: (a) one of the pair of polarizers that faces the display surface of the liquid crystal panel, (b) one of the pair of substrates that faces the backlight, (c) one of the optical members that faces an external surface of the substrate that faces the backlight, which surface is opposite to an internal surface of the substrate that faces the liquid crystal layer, and (d) a pressure sensitive adhesive layer for adhering the optical member.

Further, as described above, a television receiver of the present invention includes the liquid crystal display device.

In the arrangements, the liquid crystal display device and the television receiver absorb light in the near-infrared region. From this reason, it is not necessary to attach, to the liquid crystal panel, a near-infrared region absorbing member to be provided separately from the liquid crystal panel. As a result, with each of the arrangements, it is possible to provide a liquid crystal display device which can shield near-infrared light emitted from a backlight and which has a higher production yield compared with a case where a display filter is attached to a display screen.

More specifically, as has been already described, in such a case where the near-infrared region absorbing member is provided in the liquid crystal panel, it is not necessary to produce a near-infrared region absorbing member separately from the liquid crystal panel, with the result that the number of components does not increase. Further, in a case where a display filter produced separately from a liquid crystal panel is attached to a display surface of the liquid crystal panel, the following problem is caused. That is, when either one of the panel and, the filter is defective, a set of the panel and the filter is defective, thereby increasing a defective ratio. However, in the arrangements of the present invention, since the near-infrared region absorbing member is a constituent of the liquid crystal panel, such the problem does not occur so that the defective ratio does not increase. Consequently, it is possible to provide a liquid crystal display device which can shield near-infrared light emitted from a backlight, and which has a higher production yield and is produced at a lower production cost compared with a case where a display filter is attached to a display screen.

Moreover, in a case where the near-infrared region absorbing member is provided closer to the backlight than the liquid crystal panel, it is not necessary to attach the near-infrared region absorbing member to the liquid crystal panel by use of an adhesive material (a pressure sensitive adhesive material). In this case, even if either one of the liquid crystal panel and the near-infrared region absorbing member is defective, it is possible to easily replace the defective one without detaching the near-infrared region absorbing member from the panel. As a result, it is possible to provide, at a low cost, a liquid crystal display device which can shield near-infrared light emitted from a backlight, and which has a higher production yield compared with a case where a display filter is attached to a display screen.

According to the each of the arrangement, in a case where the near-infrared region absorbing member is provided closer to a display surface than a liquid crystal layer in the liquid crystal panel, only the polarizer that faces the display surface can be the near-infrared region absorbing member. On this account, the each of the arrangements (i) improves a production yield, and (ii) does not cause problems which occur in a case where a near-infrared absorbing display filter is attached to a display panel: for example, a problem caused due to air coming into an interface between the display panel and the near-infrared absorbing display filter; and a problem for detaching the display filter from the panel. Further, with the each of the arrangements, it is possible to shield the light in the near-infrared region without decreasing luminance and brightness. This does not decrease a display quality.

In this way, with the each of the arrangement, it is possible to provide a liquid crystal display device and a television receiver, each of which can shield near-infrared light emitted from a backlight without decreasing a display quality.

It is preferable that the near-infrared region absorbing member have an absorptance of at least 30%, more preferably an absorptance of at least 50% with respect to the light in the near-infrared region.

As described above, the near-infrared region absorbing member is provided in the liquid crystal display device. Therefore, with the arrangement, even if light having a wavelength in the near-infrared region is emitted from the backlight, at least 30%, more preferably 50% of the light is absorbed. As a result, it is possible to more surely prevent malfunctions of a peripheral electronic device of the liquid crystal display device when the peripheral electronic device is operated by a remote controller, which malfunctions are caused due to the light having a wavelength in the near-infrared region, emitted from the backlight.

Especially, generally, a liquid crystal display device as a noise source and a peripheral device of the liquid crystal display device, which peripheral device is to be caused to malfunction, are placed, in most cases, with a distanced space of at least one tatami mat via noise reflection from a wall or the like. A long side of the one tatami mat is 1.8 m. As has been already described, as results of the check tests by the inventors of the present invention, the followings were demonstrated. That is, in the case where the near-infrared region absorbing member has an absorptance of 50% and the distanced space is not less than 2 m, it is possible to obtain a state substantially equivalent to a state in which no noise source is placed around the peripheral device. As a result, in the case where the absorptance is not less than 50% with respect to the light in the near-infrared region, it is possible that the peripheral device hardly causes malfunctions.

Further, as described above, the liquid crystal display device of the present invention including a liquid crystal panel and a backlight, may further include a near-infrared region absorbing member that has an absorptance at least 30% with respect to the near-infrared (900 nm to 1100 nm) region. The television receiver of the present invention may include the liquid crystal display device.

As a result, it is possible to provide a liquid crystal display device and a television receiver, each of which can further shield near-infrared light emitted from a backlight without decreasing a display quality.

Further, in the liquid crystal display device, the liquid crystal panel may include the near-infrared region absorbing member. That is, the near-infrared region absorbing member, which may be provided either in the liquid crystal panel or between the liquid crystal panel and the backlight, may be provided in the liquid crystal panel.

The arrangement allows the liquid crystal panel itself to have a function of absorbing the light in the near-infrared region.

Further, in the liquid crystal display device, it is preferable that the liquid crystal panel include a pair of polarizers, which sandwich a liquid crystal cell therebetween, and at least one of the pair of polarizers be the near-infrared region absorbing member. That is, it is preferable that the near-infrared region absorbing member be at least one of the pair of polarizers.

In the arrangement, the pair of polarizers provided in the liquid crystal panel that is essential for the liquid crystal display device is a near-infrared region absorbing member, thereby resulting in that the number of components does not increase.

Moreover, in the liquid crystal display device, it is preferable that the at least one of the pair of polarizers be made from a material containing iodine and a dye that absorbs the light in the near-infrared region of 900 nm to 1100 nm.

Generally, a polarizer is made from iodine. However, the liquid crystal display device of the present invention, in addition to the iodine, a dye that absorbs the light in the near-infrared region is also contained in the polarizer. The iodine has absorbability with respect to visible light. When the iodine is drawn so as to be oriented, this causes the iodine to have a lattice-shaped part having a characteristic of absorbing visible light and a blank space part having a characteristic of passing visible light therethrough. In the liquid crystal display device of the present invention, the lattice-shaped part having a characteristic of absorbing visible light also absorbs light in the near-infrared region.

As such, in the above arrangement, the near-infrared region absorbing member is at least one of the polarizers made from a material containing the iodine and the dye that absorbs the light in the near-infrared region. As a result, it is possible to realize a liquid crystal display device that can shield near-infrared light emitted from a backlight, without decreasing a display quality.

Furthermore, in the liquid crystal display device of the present invention, at least one optical member may be provided in a sheet-like or plate-like form between the backlight and the liquid crystal panel, and at least one of the at least one optical member may be the near-infrared region absorbing member.

The arrangement makes it possible that the near-infrared region absorbing member is provided between the backlight and the liquid crystal panel, not in the liquid crystal panel itself. The term “sheet-like form” indicates a relatively thin form having no stiffness, and the term “plate-like form” indicates a form having a thickness and stiffness.

In the liquid crystal display device of the present invention, a backlight includes a light diffusing plate, which backlight is provided on a backside of the liquid crystal panel including a liquid crystal cell sandwiched between the pair of polarizers. In the liquid crystal display device, the near-infrared region absorbing member is a near-infrared region absorbing polarizer made from a material containing iodine and a dye that absorbs the light in the near-infrared (900 nm to 1100 nm) region, and is provided between the liquid crystal panel and the light diffusing plate of the backlight.

It is preferable that the near-infrared region absorbing member be made from a material containing iodine and a dye that absorbs the light in the near-infrared region of 900 nm to 1100 nm.

The arrangement makes it possible to provide a liquid crystal display device which can shield the light in the near-infrared region without decreasing luminance, and which can shield near-infrared light emitted from a backlight without decreasing a display quality.

Moreover, in the liquid crystal display device of the present invention, the backlight includes a light diffusing plate on a side from which light from a light source is emitted, and the near-infrared region absorbing member is provided between the liquid crystal panel and the light diffusing plate.

That is, the near-infrared region absorbing member is not necessarily the pair of polarizers, which sandwich the liquid crystal cell, and can be provided between the liquid crystal panel and the light diffusing plate of the backlight.

Further, in the liquid crystal display device of the present invention, the backlight includes a light diffusing plate on a side from which light from a light source is emitted. The liquid crystal display device further includes a diffusing sheet, a light-collecting sheet, and a polarized light reflecting sheet, the sheets being provided in this order from the light diffusing plate, between the light diffusing plate of the backlight and the liquid crystal panel. In the liquid crystal display device, the near-infrared region absorbing member may be provided at least (i) between the light diffusing plate and the diffusing sheet, (ii) between the light diffusing plate and the light-collecting sheet, or (iii) between the light-collecting sheet and the polarized light reflecting sheet.

In the arrangement, in the liquid crystal display device of the present invention, for example, in order that the backlight can efficiently generate light, the diffusing sheet, the light-collecting sheet, and the polarized light reflecting sheet are provided in this order from the light diffusing plate, between the light diffusing plate of the backlight and the liquid crystal panel. In this case, if the near-infrared region absorbing member is provided at least (i) between the light diffusing plate and the diffusing sheet, (ii) between the diffusing sheet and the light-collecting sheet, or (iii) between the collecting sheet and the polarized light reflecting sheet, it is possible to shield near-infrared light emitted from the backlight.

In the liquid crystal display device of the present invention, a backlight includes a light diffusing plate on a side from which light from a light source is emitted. The liquid crystal display device further includes a diffusing sheet, a light-collecting sheet, and a polarized light reflecting sheet, the sheets being provided in this order from the light diffusing plate, between the light diffusing plate of the backlight and the liquid crystal panel. In the liquid crystal display device, it is preferable that the near-infrared region absorbing member be provided between the polarized light reflecting sheet and the liquid crystal panel, and the near-infrared region absorbing member have a retardation Δn·d of less than 100 nm (Δn·d<100).

In a case where the near-infrared region absorbing member is provided on the polarized light reflecting sheet, it is necessary that the near-infrared region absorbing member have a low retardation. In this regard, when the retardation (Δn·d) of the near-infrared region absorbing member is set less than 100 (Δn·d<100), the near-infrared region absorbing member has a low retardation. This enables an arrangement in which a decrease in luminance is prevented.

In this case, it is preferable that a substrate of the near-infrared region absorbing member be made from polycarbonate, olefin resin, or triacetyl cellulose.

These materials easily allow the near-infrared region absorbing member to have a low retardation.

In the liquid crystal display device of the present invention, the backlight includes a light diffusing plate on a side from which light from a light source is emitted. The liquid crystal display device further includes a diffusing sheet, a light-collecting sheet, and a polarized light reflecting sheet, the sheets being provided in this order from the light diffusing plate, between the light diffusing plate of the backlight and the liquid crystal panel. In the liquid crystal display device, it is preferable that the near-infrared region absorbing member be provided between the polarized light reflecting sheet and the liquid crystal panel, and the near-infrared region absorbing member include a base material in which either a long axis or a short axis of an index ellipsoid is parallel to an absorption axis or a transmission axis of the polarizers of the liquid crystal panel.

When drawing axes are set in the same direction as such, it is possible to obtain an effect similar to the low retardation.

Further, the liquid crystal display device of the present invention, it is preferable that the dye have a plurality of conjugate double bonds.

Since a conjugate double bond is capable of absorbing light in the near-infrared region, such the arrangement in which the plurality of conjugate double bonds are included improves absorbability of the light in the near-infrared region.

Further, in the liquid crystal display device of the present invention, the backlight includes a light source constituted by discharge lamp tubes.

The backlight constituted by discharge lamp tubes emits light in the near-infrared from inactive gas such as neon (Ne) and argon (Ar), and mercury (Hg). However, with the above arrangement, the liquid crystal display device can shield the near-infrared light emitted from the backlight.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is applicable to a liquid crystal display device and a television receiver, each including a backlight.

1. A liquid crystal display device comprising:
(I) a liquid crystal panel including (i) a pair of substrates, which sandwich a liquid crystal layer therebetween, and (ii) optical members each provided so as to face an external surface of each of the pair of substrates, which surface is opposite to an internal surface of the each of the pair of substrates that faces the liquid crystal layer, the optical members each including a polarizer in pair; and
(II) a backlight provided so as to face a surface of the liquid crystal panel, the surface being opposite to a display surface of the liquid crystal panel,
said liquid crystal display device further comprising:
a near-infrared region absorbing member, which absorbs light in a near-infrared region of 900 nm to 1000 nm, the near-infrared region absorbing member being provided at least either in the liquid crystal panel or between the liquid crystal panel and the backlight,
in a case where the near-infrared region absorbing member is provided in the liquid crystal panel, the near-infrared region absorbing member in the liquid crystal panel being at least one of the following members: (a) one of the pair of polarizers that faces the display surface of the liquid crystal panel, (b) one of the pair of substrates that faces the backlight, (c) one of the optical members that faces an external surface of the substrate that faces the backlight, which surface is opposite to an internal surface of the substrate that faces the liquid crystal layer, and (d) a pressure sensitive adhesive layer for adhering the optical member.

2. The liquid crystal display device as set forth in claim 1, wherein:
the near-infrared region absorbing member has an absorptance of at least 30% with respect to the light in the near-infrared region.

3. The liquid crystal display device as set forth in claim 1, wherein:
the near-infrared region absorbing member is provided in the liquid crystal panel, which near-infrared region absorbing member is to be provided either in the liquid crystal panel or between the liquid crystal panel and the backlight.

4. The liquid crystal display device as set forth in claim 3, wherein:
the near-infrared region absorbing member is at least one of the pair of polarizers.

5. The liquid crystal display device as set forth in claim 4, wherein:
the at least one of the pair of polarizers is made from a material containing iodine and a dye that absorbs the light in the near-infrared region of 900 nm to 1100 nm.

6. The liquid crystal display device as set forth in claim 1, comprising:
at least one optical member in a sheet-like or plate-like form between the backlight and the liquid crystal panel,
at least one of the at least one optical member being the near-infrared region absorbing member.

7. The liquid crystal display panel as set forth in claim 6, wherein:
the near-infrared region absorbing member is a near-infrared region absorbing polarizer made from a material containing iodine and a dye that absorbs the light in the near-infrared region of 900 nm to 1100 nm.

8. The liquid crystal display device as set forth in claim 1, and wherein:
the backlight includes a light diffusing plate on a side from which light from a light source is emitted, and
the near-infrared region absorbing member is provided between the liquid crystal panel and the light diffusing plate.

9. The liquid crystal display device as set forth in claim 1, wherein:
the backlight includes a light diffusing plate on a side from which light from a light source is emitted;
said liquid crystal display device further comprises:
a diffusing sheet;
a light-collecting sheet; and
a polarized light reflecting sheet, the sheets being provided in this order from the light diffusing plate, between the light diffusing plate of the backlight and the liquid crystal panel; and
the near-infrared region absorbing member is provided at least (i) between the light diffusing plate and the diffusing sheet, (ii) between the diffusing sheet and the light-collecting sheet, or (iii) between the light-collecting sheet and the polarized light reflecting sheet.

10. The liquid crystal display device as set forth in claim 1, wherein:
the backlight includes a light diffusing plate on a side from which light from a light source is emitted; and
said liquid crystal display device further comprises:
a diffusing sheet;
a light-collecting sheet; and
a polarized light reflecting sheet, the sheets being provided in this order from the light diffusing plate, between the light diffusing plate of the backlight and the liquid crystal panel; and
the near-infrared region absorbing member is provided between the polarized light reflecting sheet and the liquid crystal panel, the near-infrared region absorbing member having a retardation and of less than 100 nm.

11. The liquid crystal display device as set forth in claim 10, wherein:
a base material of the near-infrared region absorbing member is made from polycarbonate, olefin resin, or triacetyl cellulose.

12. The liquid crystal display device as set forth in claim 1, wherein:
the backlight includes a light diffusing plate on a side from which light from a light source is emitted;
said liquid crystal display device further comprises:
a diffusing sheet;
a light-collecting sheet; and
a polarized light reflecting sheet, the sheets being provided in this order from the light diffusing plate, between the light diffusing plate of the backlight and the liquid crystal panel; and
the near-infrared region absorbing member is provided between the polarized light reflecting sheet and the liquid crystal panel, the near-infrared region absorbing member including a base material in which either a long axis or a short axis of an index ellipsoid is parallel to an absorption axis or a transmission axis of the polarizers of the liquid crystal panel.

13. The liquid crystal display device as set forth in claim 5, wherein:
the dye has a plurality of conjugate double bonds.

14. The liquid crystal display device as set forth in claim 1, wherein:
the backlight includes a light source constituted by discharge lamp tubes.

15. The liquid crystal display device as set forth in claim 1, wherein:
the near-infrared region absorbing member has an absorptance of at least 50% with respect to the light in the near-infrared region.

16. A television receiver comprising a liquid crystal display device as set forth in claim 1.

17. The liquid crystal display device as set forth in claim 7, wherein: the dye has a plurality of conjugate double bonds.
